(19) United States
(12) Patent Application Publication
(10) Pub. No.: US 2021/0334800 A1
(43) Pub. Date: Oct. 28, 2021

(54) METHODS, SYSTEMS, AND DEVICES FOR MANAGING COMMUNICATION REQUESTS FROM A PLURALITY OF USERS

(71) Applicant: Standard Chartered Bank, Singapore (SG)

(72) Inventors: Ankur KANWAR, Singapore (SG); Ashutosh KUMAR, Singapore (SG)

(73) Assignee: Standard Chartered Bank, Singapore (SG)

(21) Appl. No.: 16/341,816

(22) PCT Filed: May 17, 2018
(86) PCT No.: PCT/SG2018/050240

§ 371 Date: Apr. 12, 2019

(51) Int. Cl. G06Q 20/40; G06Q 20/22; G06Q 20/34

(52) U.S. Cl. CPC G06Q 20/401; G06Q 20/351; G06Q 20/227

(57) ABSTRACT

Embodiments relate to processing communication requests. An example method may include identifying a main account and configuring virtual user accounts. The method may also include configuring virtual transaction instruments, including linking each virtual transaction instrument to one of the virtual user accounts. The method may also include, responsive to receiving a request for authorization of a payment request made using a virtual transaction instrument, returning a successful authorization for payment request and recording a deduction in balance of the virtual user account linked to the virtual transaction instrument when the balance for virtual user account is sufficient to cover transaction amount in payment request. The method may also include, responsive to receiving a request for authorization of payment request made using a virtual transaction instrument, performing a settlement process. The settlement process may include transferring, from main account, payment for the payment request when the payment request is successfully authorized.

### TECHNICAL FIELD

The present disclosure relates generally to managing and/or processing communication requests, and more specifically, to methods, systems, devices, and logic for managing and/or processing communication requests submitted by a plurality of users.

### BACKGROUND

Communication platforms, including gateways, transaction platforms, marketplaces, and the like, have become increasingly popular and widespread over the years. Many communication platforms are now available in a variety of different formats and configurations, including those pertaining to online and/or offline business-to-consumer (B2C), business-to-business (B2B), and/or consumer-to-business (C2B) commerce. Recent advances in technology and communications have contributed to such increased variety and widespread use of communication platforms.

### BRIEF SUMMARY

Presently, communication platforms, including gateways, transaction platforms, marketplaces, and the like (herein referred to as a “transaction platform”), have been implemented in and/or for a variety of different offerings, formats, configurations, regions, industries, etc. Oftentimes, transaction platforms will allow, and sometimes even require, registered members, users, providers, and/or participants to conduct transactions via the transaction platform and subsequently settle such transactions at a later time. Transactions conducted on such transaction platforms may include any type of communication and/or transaction. For such transaction platforms, one or more entities may be advancing and/or fronting some form of information and/or value (e.g., payment, credit, goods, services, etc.) for some or all transactions conducted on the transaction platform. It is recognized in the present disclosure that such advancing and/or fronting of information and/or value may be in the order of days, weeks, or sometimes even months before settlement is made for such transactions. It is also recognized in the present disclosure that the one or more entities advancing and/or fronting the information and/or value may also be effectively taking or holding some form of risk for such transactions.

Present example embodiments relate generally to and/or comprise systems, subsystems, processors, devices, logic, methods, and processes for addressing conventional problems, including those described above and in the present disclosure, and more specifically, example embodiments relate to systems, subsystems, processors, devices, logic, methods, and processes for managing communication requests, or the like, from a plurality of users, including those submitted via one or more transaction platforms, or the like.

In an exemplary embodiment, a system is described. The system may be for managing and/or processing communication requests, including those submitted via one or more transaction platforms. The system may include a configurator, transactor, aggregator, recorder, authorizer, and/or reconciler. The configurator may be configurable to identify a plurality of users of the transaction platform (e.g., registered users). The configurator may also be configurable to identify one or more main accounts assigned to a main user. The one or more main accounts may be configured to make payments on behalf of the plurality of registered users. The configurator may also be configurable to configure a plurality of virtual user accounts (e.g., virtual bank accounts). Such configuring may include linking the plurality of virtual user accounts to one or more of the main accounts. Each virtual user account may be assigned to one or more of the registered users. The configurator may also be configurable to configure a plurality of virtual transaction instruments (e.g., virtual debit card or virtual credit card). Such configuring may include linking each virtual transaction instrument to one or more of the virtual user accounts. The transactor may be configurable to route deposits received for each of the virtual user accounts (as configured by the configurator) directly to the main account that is linked to the virtual user accounts. For example, when a user assigned to a virtual user account makes a deposit of funds to the virtual user account, such funds may be deposited directly to the main account linked to the virtual user account. In this regard, the virtual user account may have a balance that is updated to reflect such deposits. The transactor may also be configurable to route payments from one or more of the main accounts, such as payments on behalf of one or more users for authorized transactions conducted by the one or more users using a virtual transaction instrument. The aggregator may be configurable to establish a communication channel with one or more of the transaction platforms. The aggregator may also be configurable to receive a request for authorization of a payment request made using one of the virtual transaction instruments configured by the configurator. The aggregator may also be configurable to receive one or more authorization reports summarizing successful authorizations of payment requests received by the one or more transaction platforms. The recorder may be configurable to maintain a real-time balance for each virtual user account configured by the configurator. The authorizer may be configurable to, for each request for authorization received by the aggregator, identify a transaction amount in the payment request. The authorizer may be configurable to, for each request for authorization received by the aggregator, identify the virtual transaction instrument configured by the configurator used to make the payment request. The authorizer may be configurable to, for each request for authorization received by the aggregator, identify the virtual user account configured by the configurator to be directly linked to the identified virtual transaction instrument. The authorizer may be configurable to, for each request for authorization received by the aggregator and when the real-time balance for the identified virtual user account maintained by the recorder is sufficient to cover the identified transaction amount in the payment request, identify the payment request as being successfully authorized. The authorizer may be configurable to, for each request for authorization received by the aggregator and when the real-time balance for the identified virtual user account maintained by the recorder is sufficient to cover the identified transaction amount in the payment request, transmit a successful authorization for the payment request. The authorizer may be configurable to, for each request for authorization received by the aggregator and when the real-time balance for the identified virtual user account maintained by the recorder is sufficient to cover the identified transaction amount in the payment request, update the real-time balance maintained by the recorder with the identified transaction amount. The reconciler may be configurable to select, from the authorization reports received by the aggregator, successfully authorized payment requests that match the payment requests identified by the authorizer as being successfully authorized. The reconciler may also be configurable to instruct the transactor to make payment for the selected payment requests. It is to be understood in the present disclosure that example embodiments of the system may include, not include, communicate with, or not communicate with one or more of the elements described above and in the present disclosure, may include or communicate with additional elements, may include or communicate with equivalent elements, may be formed, implementable/implemented, and/or used in different sequences, actions, combinations, and/or configurations, and/or one or more of the elements (and/or elements of elements) may be combinable into a single element or divided into two or more elements.

In another exemplary embodiment, a method is described. The method may be for managing and/or processing communication requests, including those submitted via one or more transaction platforms. The method may include identifying one or more main accounts for a main user. The one or more main accounts may be for use by the main user to settle payments on behalf of a plurality of users for transactions submitted by the plurality of users via one or more transaction platforms. The plurality of users may be users of the transaction platform(s) (e.g., registered users). The method may also include creating a plurality of virtual user accounts (e.g., virtual bank accounts), including a first virtual user account and a second virtual user account. Each virtual user account may be configurable to be linked to the main account in such a way that deposits made to the virtual user account are directly routed to the main account. For example, when a user assigned to a virtual user account makes a deposit of funds to the virtual user account, such funds may be deposited directly to the main account linked to the virtual user account. The method may also include linking each of the plurality of users to one of the virtual user accounts, including linking the first virtual user account to the first user and linking the second virtual user account with the second user. The method may also include creating a plurality of virtual transaction instruments (e.g., virtual debit card or virtual credit card), including a first user virtual transaction instrument and a second user virtual transaction instrument. The method may also include linking each virtual transaction instrument to one of the virtual user accounts, including linking the first user virtual transaction instrument to the first virtual user account and linking the second user virtual transaction instrument to the second virtual user account. The method may also include routing or directing deposit transactions made to each virtual user account directly to the main account, including routing or directing deposit transactions made to the first virtual user account to the main account and routing or directing deposit transactions made to the second virtual user account to the main account. The method may also include receiving requests for authorization of payment requests made using the virtual transaction instruments, including payment requests made using the first user virtual transaction instrument and payment requests made using the second user virtual transaction instrument. The method may also include performing an authorization process to determine whether or not to authorize the payment requests made using the virtual transaction instruments. The authorization process may include quantifying or determining a real-time balance for the first virtual user account. The quantifying or determining of the real-time balance for the first virtual user account may be based on at least deposit transactions made to the first virtual user account and previous payment requests made using the first virtual transaction instrument that have been successfully authorized. The authorization process may also include quantifying or determining a real-time balance for the second virtual user account. The quantifying or determining of the real-time balance for the second virtual user account may be based on at least deposit transactions made to the second virtual user account and previous payment requests made using the second virtual transaction instrument that have been successfully authorized. The authorization process may also include, for each payment request made using the first virtual transaction instrument that requires authorization, identifying a transaction amount in the payment request. The authorization process may also include, for each payment request made using the first virtual transaction instrument that requires authorization and responsive to a determination that the quantified or determined real-time balance of the first virtual user account is sufficient to cover the transaction amount in the payment request, returning a successful authorization for the payment request and recording a deduction in the balance of the first virtual user account. The authorization process may also include, for each payment request made using the first virtual transaction instrument that requires authorization and responsive to a determination that the quantified or determined real-time balance of the first virtual user account is not sufficient to cover the transaction amount in the payment request, returning an unsuccessful authorization for the payment request and not recording a deduction in the balance of the first virtual user account. The authorization process may also include, for each payment request made using the second user virtual transaction instrument that requires authorization, identifying a transaction amount in the payment request. The authorization process may also include, for each payment request made using the second user virtual transaction instrument that requires authorization and responsive to a determination that the quantified or determined real-time balance of the second virtual user account is sufficient to cover the transaction amount in the payment request, returning a successful authorization for the payment request and recording a deduction in the balance of the second virtual user account. The authorization process may also include, for each payment request made using the second user virtual transaction instrument that requires authorization and responsive to a determination that the quantified or determined real-time balance of the second virtual user account is not sufficient to cover the transaction amount in the payment request, returning an unsuccessful authorization for the payment request and not recording a deduction in the balance of the second virtual user account. The method may also include receiving one or more authorization reports summarizing the payment requests that have received successful authorizations from the authorization process. The method may also include performing a reconciliation process. The reconciliation process may include selecting the successfully authorized payment requests summarized in the authorization reports that match the successfully authorized payment requests recorded during the authorization process. The method may also include performing a settlement process. The settlement process may include transferring, from one or more of the main accounts, payments for the payment requests selected in the reconciliation process. It is to be understood in the present disclosure that example embodiments of the method may include or not include one or more of the actions described above and in the present disclosure, may include additional actions, operations, and/or functionality, may be performed in different sequences and/or combinations, and/or one or more of the actions, operations, and/or functionality may be combinable into a single action, operation, and/or functionality and/or divided into two or more actions, operations, and/or functionalities.

In another exemplary embodiment, a method is described. The method may be for managing and/or processing communication requests, including those submitted via one or more transaction platforms. The method may include identifying one or more main accounts for a main user. The one or more main accounts may be for use by the main user to settle payments on behalf of a plurality of users for transactions submitted by the plurality of users via one or more transaction platforms. The plurality of users may be users of the transaction platform(s) (e.g., registered users). The method may also include configuring a plurality of virtual user accounts (e.g., virtual bank account) to be linked to the one of the main accounts in such a way that deposits made to each of the virtual user accounts are directly routed to the main account. Each virtual user account may be assigned to one of the plurality of users. The method may also include configuring a plurality of virtual transaction instruments (e.g., virtual debit card or virtual credit card) in such a way that each virtual transaction instrument is linked to one of the virtual user accounts. The method may also include, responsive to receiving a request for authorization of a payment request made using one of the virtual transaction instruments, performing a quantifying or determining of a real-time balance for the virtual user account that is directly linked to the virtual transaction instrument used to make the payment request. The method may also include, responsive to receiving a request for authorization of a payment request made using one of the virtual transaction instruments, performing an identifying of a transaction amount in the payment request. The method may also include, responsive to receiving a request for authorization of a payment request made using one of the virtual transaction instruments, performing a returning of a successful authorization for the payment request and recording of a deduction in the balance of the virtual user account when the quantified real-time balance for the virtual user account is sufficient to cover the transaction amount in the payment request. The method may also include, responsive to receiving a request for authorization of a payment request made using one of the virtual transaction instruments, performing a returning of an unsuccessful authorization for the payment request and not recording a deduction in the balance of the virtual user account when the quantified real-time balance for the virtual user account is insufficient to cover the transaction amount in the payment request. The method may also include receiving one or more authorization reports summarizing the payment requests that have received successful authorizations. The method may also include performing a reconciliation process. The reconciliation process may include selecting the successfully authorized payment requests summarized in the authorization reports that match the recorded successfully authorized payment requests. The method may also include performing a settlement process. The settlement process may include transferring, from one or more of the main accounts, payments for the payment requests selected in the reconciliation process. It is to be understood in the present disclosure that example embodiments of the method may include or not include one or more of the actions described above and in the present disclosure, may include additional actions, operations, and/or functionality, may be performed in different sequences and/or combinations, and/or one or more of the actions, operations, and/or functionality may be combinable into a single action, operation, and/or functionality and/or divided into two or more actions, operations, and/or functionalities.

In another exemplary embodiment, a method is described. The method may be for managing and/or processing communication requests, including those submitted via one or more transaction platforms. The method may include identifying a main account for a main user. The main account may be for use by the main user to make payments on behalf of a plurality of users. The plurality of users may be users of the transaction platform(s) (e.g., registered users). The method may also include configuring a plurality of virtual user accounts (e.g., virtual bank accounts). The configuring of the plurality of virtual user accounts may include linking the plurality of virtual user accounts to the main account. Each virtual user account may be assigned to one of the plurality of users. The method may also include configuring a plurality of virtual transaction instruments (e.g., virtual debit card or virtual credit card). The configuring of the plurality of virtual transaction instruments may include linking each virtual transaction instrument to one of the virtual user accounts. The method may also include, responsive to receiving a request for authorization of a payment request made using one of the virtual transaction instruments, performing a returning of a successful authorization for the payment request and recording a deduction in a balance of a virtual user account linked to the virtual transaction instrument when the balance for the virtual user account is sufficient to cover a transaction amount in the payment request. The method may also include, responsive to receiving a request for authorization of a payment request made using one of the virtual transaction instruments, performing a settlement process. The settlement process may include transferring, from the main account, payment for the payment request when the payment request is successfully authorized. It is to be understood in the present disclosure that example embodiments of the method may include or not include one or more of the actions described above and in the present disclosure, may include additional actions, operations, and/or functionality, may be performed in different sequences and/or combinations, and/or one or more of the actions, operations, and/or functionality may be combinable into a single action, operation, and/or functionality and/or divided into two or more actions, operations, and/or functionalities.

### BRIEF DESCRIPTION OF THE DRAWINGS

For a more complete understanding of the present disclosure, example embodiments, and their advantages, reference is now made to the following description taken in conjunction with the accompanying drawings, in which like reference numbers indicate like features, and:

FIG. 1 is an illustration of an example of transacting in the travel industry via a transaction platform;

FIG. 2 is an illustration of an example embodiment of a method of managing and/or processing communication requests;

FIG. 3 is an illustration of an example embodiment of a method of configuring virtual user accounts;

FIG. 4 is an illustration of an example embodiment of a method of configuring virtual transaction instruments;

FIG. 5 is an illustration of an example embodiment of a method of performing an authorization process;

FIG. 6 is an illustration of an example embodiment of a method of performing a reconciliation process;

FIG. 7 is an illustration of an example embodiment of a system for managing and/or processing communication requests; and

FIG. 8 is an illustration of an example embodiment of a system for managing and/or processing communication requests.

Although similar reference numbers may be used to refer to similar elements in the figures for convenience, it can be appreciated that each of the various example embodiments may be considered to be distinct variations.

Example embodiments will now be described with reference to the accompanying drawings, which form a part of the present disclosure and which illustrate example embodiments which may be practiced. As used in the present disclosure and the appended claims, the terms “embodiment,” “example embodiment,” “exemplary embodiment.” and “present embodiment” do not necessarily refer to a single embodiment, although they may, and various example embodiments may be readily combined and/or interchanged without departing from the scope or spirit of example embodiments. Furthermore, the terminology as used in the present disclosure and the appended claims is for the purpose of describing example embodiments only and is not intended to be limitations. In this respect, as used in the present disclosure and the appended claims, the term “in” may include “in” and “on,” and the terms “a,” “an,” and “the” may include singular and plural references. Furthermore, as used in the present disclosure and the appended claims, the term “by” may also mean “from,” depending on the context. Furthermore, as used in the present disclosure and the appended claims, the term “if” may also mean “when” or “upon,” depending on the context. Furthermore, as used in the present disclosure and the appended claims, the words “and/or” may refer to and encompass any and all possible combinations of one or more of the associated listed items.

### DETAILED DESCRIPTION

Oftentimes, transaction platforms may allow, and sometimes even require, members, users, providers, and/or participants of a transaction platform to conduct transactions through or via the transaction platform and subsequently settle such transactions through or via the transaction platform (e.g., make payment for the transactions after receiving an invoice). Examples of transactions conducted on such transaction platforms may include, but are not limited to, simple transactions; complex transactions; transactions that are regulated or governed by a regulating or central body; transactions involving products and/or services that are regulated or governed by a regulating or central body; and/or transactions involving rapidly fluctuating and/or changing availability, price, selection, and/or merchants/providers/sellers/etc. Settlement of such transactions may be required (e.g., to avoid a late payment fee) within a specified period of time, such as within 5-15 days of a date indicated on a statement or invoice. The statement or invoice may be issued by the transaction platform, merchant/provider/seller, financial institution, other third party, etc. For such situations, one or more entities may be advancing and/or fronting some form of value (e.g., payment, cash, credit, goods, services, etc.), and such advancing and/or fronting of value may be from the time the transaction is made (or shortly thereafter) or the time a product, service, or other offering is reserved, taken off the market, and/or delivered to about the time the transaction is approved and/or settled (e.g., the time when payment is received). For example, an entity may be advancing and/or fronting payment to one or more merchants, providers, sellers, operators, retailers, or agent thereof (herein referred to as a “provider”) on behalf of the user, purchaser, buyer, or agent thereof (herein referred to as a “user”). As another example, the provider may be advancing and/or fronting its products, services, and/or other offerings to the user, middleman, or agent thereof (such advancing and/or fronting may also include holding, reserving, removing from the market, etc.). It is recognized in the present disclosure that such advancing and/or fronting of value may be in the order of days, weeks, or sometimes even months before the transaction is settled. For example, if a statement or invoice takes 1-3 days to issue and settlement (e.g., payment) is required within 5-15 days, there is a potential for such advancing and/or fronting of value (e.g., payment, products, and/or services) to be in the order of 18 days or more. Furthermore, it is recognized in the present disclosure that the one or more entities advancing and/or fronting the value may also be effectively and/or inherently taking or holding a credit risk (e.g., a risk that the user may never settle or pay for the transaction). In such case, the one or more entities that advanced and/or fronted the value may eventually take a loss for the entire value of the transaction and not just the time-value of money in advancing and/or fronting the value of the transaction. It is also recognized in the present disclosure that administrative burdens may also be placed on the one or more entities, including the provider and/or the entity or entities advancing and/or fronting the value (e.g., issuing invoices, keeping track of outstanding transactions, reconciling transactions, settling transactions, etc.).

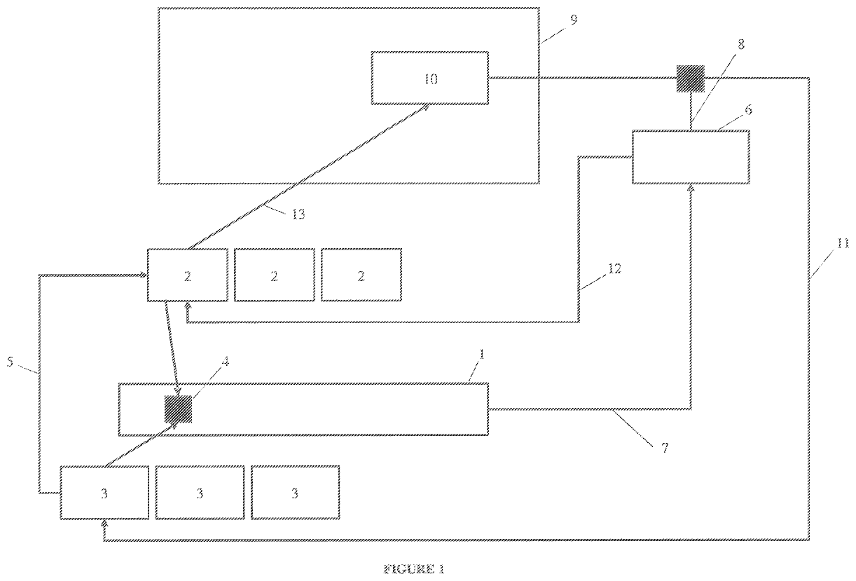

As a more specific example, FIG. 1 also illustrates a high level conventional example of transactions conducted and settled for the FMCG industry. Transaction platform 1 (e.g., one or more distribution platforms for distributors) may enable users 2 (e.g., retailers, sub-distributors, etc.) and providers 3 (e.g., suppliers, manufacturers, etc.) to transact 4 with one another via the transaction platform 1. When a user 2 agrees to enter into a transaction with a provider 3 via the transaction platform 1, the provider 3 may promptly issue a corresponding order confirmation 5 and/or purchase order to the user 2 without receiving payment right away. A main user 6 (e.g., distributor etc.) may periodically receive a summary or report of all transactions made by such users 2 on the transaction platform 1 that require settlement 7. If an agreement is in place (e.g., between the main user 6, the user 2, and/or the provider 3), the main user 6 may promptly instruct 8 a financial institution 9 of the main user 6 to make payment 11 of such outstanding transactions on behalf of the users 2 to the providers 3 using funds from the bank account 10 of the main user 6 (or wait for payment from the users 2 before paying the providers 3). The main user 6 may also send a payment invoice 12, or the like, to each user 2 outlining all outstanding transactions that require settlement by the user 2. Generally, settlement terms for such payment invoices 12 may be between about 10-15 days, or more or less. It is also recognized in the present disclosure that, in such situations, the main user 6 may be taking a credit risk each time the main user 6 advances and/or fronts value to the provider 3 on behalf of the users 2. Furthermore, it is recognized in the present disclosure that the main user 6 may have administrative burdens of operating the fronting and/or advancing program for the users 2. It is also recognized in the present disclosure that the main user 6 may have administrative burdens of performing settlements, reconciliations, etc. of the outstanding transactions (i.e., transactions where the main user 6 fronts and/or advances value). It is further recognized in the present disclosure that the providers 3 may have an administrative burden of tracking and/or managing such outstanding transactions and eventual payments/settlements of such outstanding transactions. As such, while the users 2 may benefit from being able to delay payment for transactions entered into via such transaction platforms 1, the main user 6 and/or providers 3 are generally disadvantaged from the standpoint of fronting and/or advancing value, delayed or lagging settlement time, credit risk, administrative burdens, etc.

As another example, FIG. 1 may also illustrate a high level conventional example of transactions conducted and settled for the travel industry. Transaction platform 1 (e.g., one or more Global Distribution Systems (or GDS), or the like, for travel bookings) may enable users 2 (e.g., consumers, travel agents, travel agencies, agents thereof, etc.) and providers 3 (e.g., airlines, hotels, trains, etc.) to transact 4 with one another via the transaction platform 1. When a user 2 agrees to enter into a transaction with a provider 3 via the transaction platform 1, the provider 3 may promptly issue a corresponding electronic ticket (or e-ticket) 5 and/or reservation to the user 2 without receiving payment right away. A main user 6 (e.g., owner, operator, and/or representative of the transaction platform; regulating or central body or trade association, etc.) may periodically receive a summary or report of all transactions made by such users 2 on the transaction platform 1 that require settlement 7 (e.g., reporting periods may vary and can be once a month, twice a month or a different frequency. If an agreement is in place (e.g., between the main user 6, the user 2, and/or the provider 3), the main user 6 may promptly instruct 8 a financial institution 9 of the main user 6 to make payment 11 of such outstanding transactions on behalf of the users 2 to the providers 3 using funds from the bank account 10 of the main user 6 (or wait for payment from the users 2 before paying the providers 3). The main user 6 may also send a payment invoice 12, or the like, to each user 2 outlining all outstanding transactions that require settlement by the user 2. Generally, settlement terms for such payment invoices 12 may be between about 10-15 days, or more or less. It is recognized in the present disclosure that, for such example situations, the main user 6 may be required to front and/or advance some form of value (e.g., payment, credit, etc.) to the providers 3 on behalf of the users 2. It is also recognized in the present disclosure that, in such situations, the main user 6 may be taking a credit risk each time the main user 6 advances and/or fronts value to the provider 3 on behalf of the users 2. Furthermore, it is recognized in the present disclosure that the main user 6 may have administrative burdens of operating the fronting and/or advancing program for the users 2. It is also recognized in the present disclosure that the main user 6 may have administrative burdens of performing settlements, reconciliations. etc. of the outstanding transactions (i.e., transactions where the main user 6 fronts and/or advances value). It is further recognized in the present disclosure that the providers 3 may have an administrative burden of tracking and/or managing such outstanding transactions and eventual payments/settlements of such outstanding transactions. As such, while the users 2 may benefit from being able to delay payment for transactions entered into via such transaction platforms 1, the main user 6 and/or providers 3 are generally disadvantaged from the standpoint of fronting and/or advancing value, delayed or lagging settlement time, credit risk, administrative burdens, etc.

In yet another example. FIG. 1 may also illustrate a high level conventional example of transactions conducted and settled for a multi-level marketing company and/or multi-level marketing industry. Transaction platform 1 (e.g., one or more order booking platforms) may enable users 2 (e.g., business owners, consumers, etc.) and providers 3 (e.g., suppliers, manufacturers, etc.) to transact 4 with one another via the transaction platform 1. When a user 2 agrees to enter into a transaction with a provider 3 via the transaction platform 1, the provider 3 may promptly issue a corresponding order confirmation 5 and/or purchase order to the user 2 without receiving payment right away. A main user 6 (e.g., distributor etc.) may periodically receive a summary or report of all transactions made by such users 2 on the transaction platform 1 that require settlement 7. If an agreement is in place (e.g., between the main user 6, the user 2, and/or the provider 3), the main user 6 may promptly instruct 8 a financial institution 9 of the main user 6 to make payment 11 of such outstanding transactions on behalf of the users 2 to the providers 3 using funds from the bank account 10 of the main user 6 (or wait for payment from the users 2 before paying the providers 3). The main user 6 may also send a payment invoice 12, or the like, to each user 2 outlining all outstanding transactions that require settlement by the user 2. Generally, settlement terms for such payment invoices 12 may be between about 10-15 days, or more or less. It is also recognized in the present disclosure that, in such situations, the main user 6 may be taking a credit risk each time the main user 6 advances and/or fronts value to the provider 3 on behalf of the users 2. Furthermore, it is recognized in the present disclosure that the main user 6 may have administrative burdens of operating the fronting and/or advancing program for the users 2. It is also recognized in the present disclosure that the main user 6 may have administrative burdens of performing settlements, reconciliations, etc. of the outstanding transactions (i.e., transactions where the main user 6 fronts and/or advances value). It is further recognized in the present disclosure that the providers 3 may have an administrative burden of tracking and/or managing such outstanding transactions and eventual payments/settlements of such outstanding transactions. As such, while the users 2 may benefit from being able to delay payment for transactions entered into via such transaction platforms 1, the main user 6 and/or providers 3 are generally disadvantaged from the standpoint of fronting and/or advancing value, delayed or lagging settlement time, credit risk, administrative burdens, etc.

In yet another example, FIG. 1 may also illustrate a high level conventional example of transactions conducted and settled for ecommerce platform companies. The transaction platform 1 and/or transaction platform owner may look to distribute rebates, commissions, incentives, profit share, or the like to underlying suppliers and/or providers 3 (e.g., drivers associated with cab-sharing or e-hailing businesses). Currently the distribution would be done through various traditional modes such as bank account transfers, cash payouts, etc. It is recognized in the present disclosure that such industries may encounter problems, such as bank account transfers across banks in many countries that may incur high charges and one or more of the problems described above and in the present disclosure.

Despite recent technological advances, including those pertaining to electronic payments and communications, it is recognized in the present disclosure that problems and/or difficulties may be encountered when users transact with providers via transaction platforms, such as those provided in the above examples. As used in the present disclosure, a “provider” may include, but is not limited to, an individual, user, business, company, partnership, corporation, provider, service provider, organization, institution, government entity, non-profitable entity, educational institution, agent or broker of any one or more of the aforementioned entities, etc. For example, a provider may include a particular airline company (e.g., domestic airlines, regional airlines, international airlines, etc.), hotel operator (e.g., hotels, motels, resorts, etc.), theme parks, ground transportation company (e.g., taxis, e-Hailing companies, trains, shuttles, etc.), logistics company, shipping company (e.g., importers, freight forwarders, etc.), tax and/or other statutory authorities. FMCG companies, cosmetics companies, oil & gas companies, pharmaceutical companies, and/or agent or broker of any one or more of the aforementioned entities. Similarly, a “user” may include, but is not limited to, an individual, user, business, company, partnership, corporation, provider, service provider, organization, institution, government entity, non-profitable entity, educational institution, agent or broker of any one or more of the aforementioned entities, etc. For example, a user may include a person, travel agent, travel agency, organization, and/or agent or broker of any one or more of the aforementioned entities.

Present example embodiments relate generally to and/or comprise systems, subsystems, processors, devices, logic, methods, and processes for addressing conventional problems, including those described above and in the present disclosure, and more specifically, example embodiments relate to systems, subsystems, processors, devices, logic, methods, and processes for managing and/or processing communication requests. As used in the present disclosure, the term “transaction request”. “communication request”, or the like, may be interchangeably used and may include, but is not limited to, a payment request, deposit request, transfer request, information request, and/or any other request for and/or relating to information, money, funds, and/or any financial and/or negotiable instrument (e.g., cash, credit, cryptocurrencies, digital tokens, etc.). Furthermore, as used in the present disclosure, the terms “account”, “main account”, “user account”, or the like, may include any type or form of account that is owned by, assigned to, linked to, registered by, associated with, controlled by, or the like (herein referred to as “assigned to”, “assign to”, “assign”, “assigning”, or the like, depending on the context), one or more entities, and may include, but are not limited to, an account with transaction platform, an account in a financial institution (e.g., bank account such as a savings account or checking account with Standard Chartered Bank, etc.; investment account; etc.), an electronic wallet (e.g., a wallet for cryptocurrencies, digital tokens, etc.), a social media account (e.g., Facebook, Instagram, Google. Line. WeChat, etc.), an email account, etc. Furthermore, as used in the present disclosure, the terms “virtual account”, “virtual user account”. “sub-virtual account”, “sub-virtual user account”, “virtual bank account”. “virtual financial account”, or the like, may include any account or series of accounts assigned, associated, and/or linked to a physical account, non-virtual account, financial account, and/or another virtual account, virtual user account, sub-virtual account, sub-virtual user account, virtual bank account, and/or virtual financial account. For example, virtual accounts may be used as a means to identify individuals, users, agents, distributors, or sub-users who may be linked to the main user (i.e., the entity that is assigned to the physical or financial account). Furthermore, as used in the present disclosure, the terms “virtual transaction instrument”. “virtual payment card”, or the like, may be interchangeably used and may include any physical, non-physical, digital, analogue, virtual, codified, encrypted, and/or non-encrypted instrument, card, medium, code, series of characters, signal, image, virtual wallet, and/or other physical or virtual representation that may be used to conduct a transaction using funds deposited and/or credit lines or limits (e.g., credit, overdraft, or the like) available (e.g., in one or more virtual accounts, non-virtual accounts, the virtual transaction instrument itself, and/or a non-virtual transaction instrument (e.g., credit card, debit card, etc.) linked to and/or associated with the virtual transaction instrument), either in part or in whole. It is to be understood in the present disclosure that one or more elements and/or aspects of example embodiments may include and/or be implement, in part or in whole, solely and/or in cooperation with other elements, using networking technologies, cloud computing, and/or distributed ledger technology (DLT) (e.g., blockchain). Although example embodiments may be described in the present disclosure as pertaining to and/or for use with the travel industry (e.g., airlines, travel agents, etc.), it is to be understood that example embodiments may also be applicable to and/or for use with other industries, for other purposes, products, and services, and in other environments, surroundings, situations, circumstances, and/or applications. As non-limiting examples, example embodiments may be for use with e-commerce platforms, logistics platforms, shipping platforms (e.g., importers, freight forwarders, etc.), tax and/or other statutory authorities, hospitalities platforms (e.g., Airbnb, Hotels.com, etc.), commodities platforms, multi-level marketing platforms (e.g., Amway, HerbalLife, etc.), FMCG platforms (e.g., Unilever, Nestle, etc.), oil & gas platforms pharma-based platforms (e.g., Zuellig, etc.), B2B platforms (e.g., supplier platforms, etc.). B2C platforms, C2B platforms, air travel-based platforms (e.g., a Global Distribution Systems (or GDS), or the like), or the like, without departing from the teachings of the present disclosure. Example embodiments will now be described below with reference to the accompanying figures, which form a part of the present disclosure.

Example Embodiments of a Method of Processing and/or Managing Transaction Requests (e.g., Method 200)

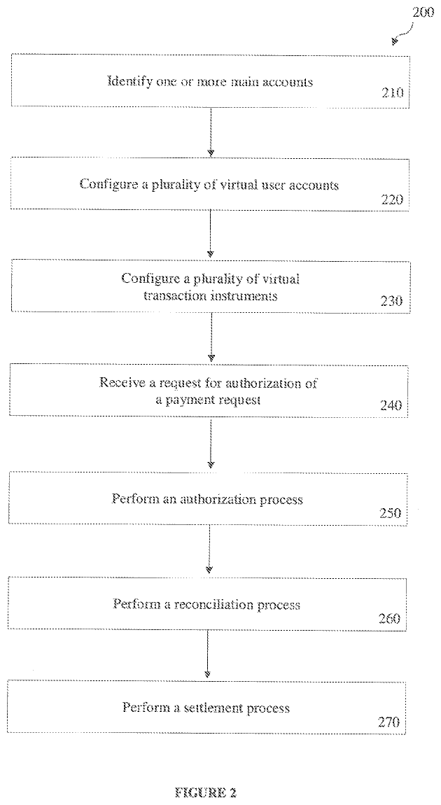

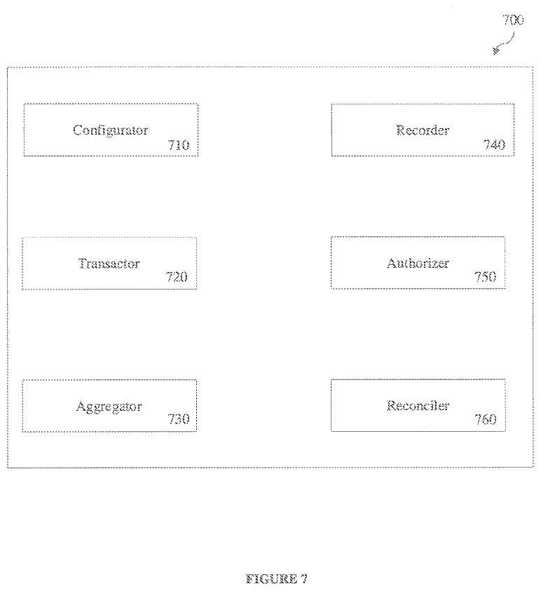

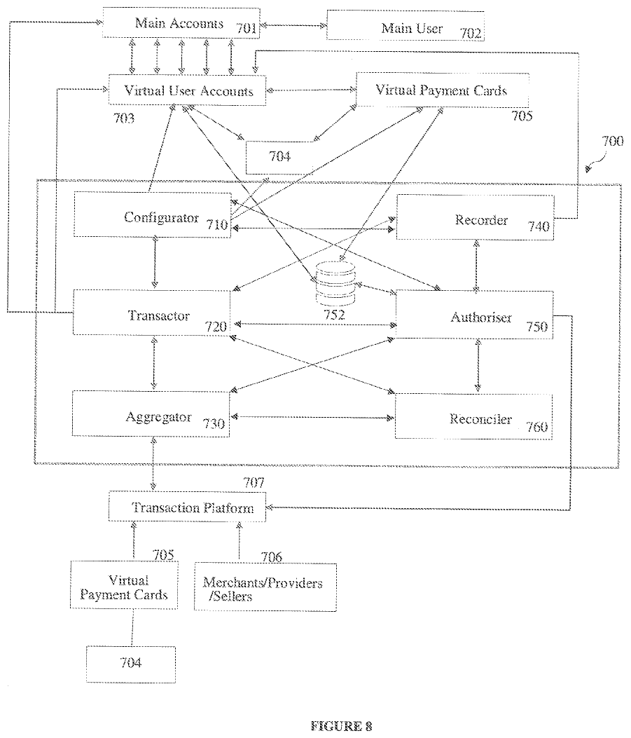

FIG. 2 illustrates an example embodiment of a method of processing and/or managing transaction requests (e.g., method 200). Transaction requests may include those submitted, transmitted, sent, transacted, entered into, agreed to, or the like (herein referred to as “submitted”, “submit”, or the like, depending on the context), in, through, or via one or more transaction platforms, or the like. Transaction requests may include those submitted by, between, for, to, and/or on behalf of one or more users, providers, and/or agents thereof. The method 200 of processing and/or managing transaction requests may be performable or performed by one or more systems, processors, and/or elements described in the present disclosure. For example, as illustrated in FIGS. 7 and 8, the method 200 of processing and/or managing transaction requests may be performable or performed by the system 700 and/or one or more elements of the system 700.

In an example embodiment, the method 200 of processing and/or managing transaction requests may include identifying one or more main accounts (e.g., action 210). Each main account may be any account (e.g., a financial account, such as a bank account, etc.) assigned to a main user (e.g., owner, operator, and/or representative of the transaction platform; distributor of goods for a FMCG company; aggregators; regulating or central body or trade association; regulating or central body or association (both international or domestic) governing various industries such as financial, insurance, healthcare, logistics, shipping, education, etc., such as the International Air Transport Association, or IATA, the Asia Pacific Exchange. or APEX, etc.). One or more main accounts may be for use by the main user to settle transactions (e.g., payment for purchases, payments for airplane ticket bookings, etc.) on behalf of one or more users (e.g., retailers, travel agents or agencies, etc.) for transactions submitted by the one or more users via one or more transaction platforms (e.g., an order booking system managed by the distributor, Global Distribution System (or GDS), or the like, for the travel industry). Alternatively or in addition, one or more main accounts may be for use by the main user to receive deposits from users. For example, as will be described in the present disclosure, when a user is assigned a virtual user account that is linked to a main account, all deposits into the virtual user account may be deposited into the main account.

The method 200 of processing and/or managing transaction requests may also include configuring one or more virtual user accounts (e.g., action 220). Each virtual user account may be any virtual account linked to, tied to, associated with, dependent on, and/or established by and/or for (herein referred to as “linked to”. “linking to”. “link to”. “linked”, “linking”. “link”, or the like, depending on the context) one or more of the main accounts. As a non-limiting example, when a main account is a bank account, a virtual user account may be a virtual bank account linked to the main account in such a way that all requests or instructions to deposit funds (e.g., direct deposit, bank transfer, wire transfer, or the like) into the virtual bank account are deposited into the main account. Furthermore, each virtual user account may have its own account number, balance, tracking of transaction history, etc., and may have a record of all deposit of funds (and any other transactions made using the virtual user account). Furthermore, each virtual user account may be assigned to one or more users (e.g., an entity or user other than the main user).

The method 200 of processing and/or managing transaction requests may also include configuring one or more sub-virtual user accounts (not shown). Each sub-virtual user account may be any virtual account linked to one or more of the virtual user accounts (e.g., the virtual user accounts in action 220). As a non-limiting example, when a virtual user account is linked to a main account (e.g., a bank account), a sub-virtual user account may be a virtual bank account linked to the virtual user account in such a way that all requests or instructions to deposit funds (e.g., direct deposit, bank transfer, wire transfer, or the like) into the sub-virtual user account are deposited into the virtual user account (e.g., the deposit is reflected in the balance of the virtual user account). Alternatively or in addition, all requests or instructions to deposit funds (e.g., direct deposit, bank transfer, wire transfer, or the like) into the sub-virtual user account may be deposited into the main account. Furthermore, each sub-virtual user account may have its own account number, balance, tracking of transaction history, etc., and may have a record of all deposit of funds (and any other transactions made using the sub-virtual user account). Furthermore, each sub-virtual user account may be assigned to one or more users (e.g., an entity or user other than the main user and the entity or user that the virtual user account is assigned to). In an example scenario, a virtual user account may be assigned to a distributor and a sub-virtual user account may be assigned to a retailer. It is to be understood in the present disclosure that the method 200 of processing and/or managing transaction requests may also include configuring one or more sub-virtual user accounts that are virtual accounts linked to one or more sub-virtual user accounts (e.g., the sub-virtual user accounts described in the present disclosure).

The method 200 of processing and/or managing transaction requests may also include configuring a plurality of virtual transaction instruments (e.g., action 230). Each virtual transaction instrument may be a virtual payment card. Each virtual transaction instrument may be linked to one or more virtual user accounts. Alternatively or in addition, each virtual transaction instrument may be linked to one or more sub-virtual user accounts. As a non-limiting example, when the virtual user account (and/or sub-virtual user account) is a virtual bank account, the virtual transaction instrument may be a virtual debit card or virtual credit card linked to the virtual bank account. Furthermore, each virtual transaction instrument may have its own account number (which may or may not be the same as the account number of the virtual user account and/or sub-virtual user account), balance (which may or may not be the same balance as the virtual user account and/or sub-virtual user account), tracking of transaction history, etc. Furthermore, each virtual transaction instrument may be assigned to one or more users (e.g., an entity or user other than the main user).

The method 200 of processing and/or managing transaction requests may also include receiving a request for authorization of a payment request (e.g., action 240). A request for authorization of a payment request may occur when a user (e.g., travel agent or agency) uses a virtual transaction instrument (e.g., a virtual debit card) to conduct a transaction (e.g., payment request to purchase an airplane ticket) via the transaction platform (e.g., a GDS for the travel industry). For such a transaction, a request for authorization may check, among other things, whether the virtual transaction instrument is authorized to conduct the transaction and/or whether the virtual user account (and/or sub-virtual user account) linked to the virtual transaction instrument has sufficient funds to complete/cover the payment request.

The method 200 of processing and/or managing transaction requests may also include performing one or more authorization processes (e.g., action 250). The one or more authorization processes may include quantifying or determining, such as by an entity (e.g., financial institution that issued or is operating/managing the main account, virtual user account, sub-virtual user account, and/or virtual transaction instrument), a balance of the virtual user account (and/or sub-virtual user account) linked to the virtual transaction instrument (which may also include an available balance or limit of the virtual transaction instrument), identifying the amount in the payment request, and ensuring the quantified or determined balance is sufficient to cover the amount in the payment request.

The method 200 of processing and/or managing transaction requests may also include performing one or more reconciliation processes (e.g., action 260). The method 200 of processing and/or managing transaction requests may also include performing one or more settlement processes (e.g., action 270).

Example embodiments of the method 200 of processing and/or managing transaction requests may include or not include one or more of the actions described above and in the present disclosure, may include additional actions, operations, and/or functionality, may be performed in different sequences and/or combinations, and/or one or more of the actions, operations, and/or functionality may be combinable into a single action, operation, and/or functionality and/or divided into two or more actions, operations, and/or functionalities. The method 200 of processing and/or managing transaction requests, and actions and elements thereof, will now be further explained with reference to the accompanying figures.

Identifying One or More Main Accounts (e.g., Action 210).

In an example embodiment, the method 200 of processing and/or managing transaction requests may include identifying one or more main accounts (e.g., action 210). The identifying of one or more main accounts 210 may be performable by example embodiments of a system for processing transaction requests (e.g., system 700 illustrated in at least FIG. 7). For example, the identifying of one or more main accounts 210 may be performable by an example embodiment of the configurator (e.g., configurator 710). Each main account may be an account assigned to one or more main users. As described above and in the present disclosure, each main account may be a financial account, such as a checking account, savings account, etc. As described above and in the present disclosure, each main account may be for use by the one or more main users to settle transactions (e.g., make payments) on behalf of a plurality of users. For example, one or more main accounts (e.g., a bank account, etc.) may be for use by a main user (e.g., distributor, aggregator, etc.) to make payments on behalf of a plurality of users (e.g., retailers, consumers, travel agents or agencies, etc.) to providers (e.g., suppliers, manufacturers, airlines, travel websites such as Expedia, etc.) for transactions submitted by the plurality of users via one or more transaction platforms (e.g., an order booking system, ecommerce portal, GDS, etc.). As will be further described in the present disclosure, one or more main accounts may be linked to a plurality of virtual user accounts (and/or sub-virtual user accounts). Each of the virtual user accounts (and/or sub-virtual user accounts) may be a virtual financial account (e.g., virtual bank account) assigned to one or more users. Furthermore, one or more virtual user accounts (and/or sub-virtual user accounts) that are linked to a main account may be assigned to a user other than the main user. Each virtual user account (and/or sub-virtual user account) may also be linked to a main account in such a way that deposits made to the virtual user account (and/or sub-virtual user account) are deposited into the main account (and may also include transactions other than deposits).

Configuring a Plurality of Virtual User Accounts (e.g., Action 220).

In an example embodiment, the method 200 of processing and/or managing transaction requests may include configuring a plurality of virtual user accounts (e.g., action 220). The configuring of the plurality of virtual user accounts 220 may be performable by example embodiments of a system for processing transaction requests (e.g., system 700 illustrated in at least FIG. 7). For example, the configuring of the plurality of virtual user accounts 220 may be performable by an example embodiment of the configurator (e.g., configurator 710). As described above and in the present disclosure, each virtual user account may be a virtual financial account (e.g., virtual bank account) assigned to one or more users. Furthermore, each virtual user account may have its own account number, balance, tracking of transaction history, etc., and may have a record of all deposit of funds (and any other transactions made using the virtual user account).

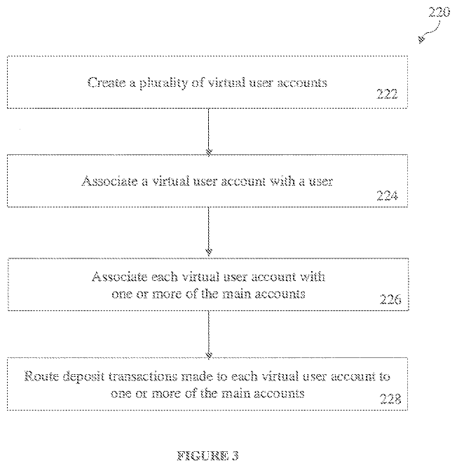

As illustrated in at least FIG. 3, the configuring of the plurality of virtual user accounts 220 may include creating a plurality of virtual user accounts (e.g., action 222). For example, an entity having virtual account creating and/or opening capabilities (e.g., a financial institution such as Standard Chartered Bank or any other bank) or an entity that instructs an entity having virtual account creating and/or opening capabilities may perform the creating of a plurality of virtual user accounts 222. The configuring of the plurality of virtual user accounts 220 may also include assigning a virtual user account to one or more users (e.g., action 224). For example, a virtual user account may be assigned to a travel agent, travel agency, etc. The virtual user account may be assigned to a user that is not the main user assigned to the main account linked to the virtual user account. It is recognized in the present disclosure that the virtual user account may be assigned to a user at any time (e.g., immediately upon creating the virtual user account or at a later stage, such as after linking the virtual user account to a virtual transaction instrument). The configuring of the plurality of virtual user accounts 220 may also include linking each virtual user account to one or more of the main accounts (e.g., action 226). For example, virtual user accounts assigned or not assigned to users may be linked to a main account assigned to a main user (e.g., distributor, aggregator, etc.). The configuring of the plurality of virtual user accounts 220 may also include routing deposits made to each virtual user account to one or more of the main accounts (e.g., action 228). For example, requests or instructions to deposit funds into virtual user accounts assigned to users (e.g., retailers, travel agents) may be directly routed and/or deposited into the main account assigned to a main user (e.g., distributor, aggregator, etc.) when such virtual user accounts are linked to such main account. As will be further described in the present disclosure, the depositing of funds by users (e.g., retailers, travel agents) into their own virtual user accounts may be considered as a deposit, pre-payment, funding, filling, and/or topping-up of their virtual transaction instruments (e.g., virtual payment card such as a virtual debit card or virtual credit card).

In an example embodiment, the method 200 of processing and/or managing transaction requests may include configuring a plurality of sub-virtual user accounts. The configuring of the plurality of sub-virtual user accounts may be performable by example embodiments of a system for processing transaction requests (e.g., system 700 illustrated in at least FIG. 7). For example, the configuring of the plurality of sub-virtual user accounts may be performable by an example embodiment of the configurator (e.g., configurator 710). As described above and in the present disclosure, each sub-virtual user account may be a virtual financial account (e.g., virtual bank account) assigned to one or more users. Furthermore, each virtual user account may have its own account number, balance, tracking of transaction history, etc., and may have a record of all deposit of funds (and any other transactions made using the sub-virtual user account). In an example embodiment, the relationship and/or functionality (e.g., funds flow, credit flow, information flow, etc.) between a sub-virtual user account and a virtual user account linked to the sub-virtual user account may be similar to, substantially the same as, or different from the relationship and/or functionality between a virtual user account and a main account linked to the virtual user account.

The configuring of the plurality of sub-virtual user accounts may include creating a plurality of sub-virtual user accounts. For example, an entity having virtual account creating and/or opening capabilities (e.g., a financial institution such as Standard Chartered Bank or any other bank) or an entity that instructs an entity having virtual account creating and/or opening capabilities may perform the creating of a plurality of sub-virtual user accounts. The configuring of the plurality of sub-virtual user accounts may also include assigning a sub-virtual user account to one or more users. For example, a virtual user account may be assigned to a distributor and a sub-virtual user account may be assigned to a retailer. The sub-virtual user account may be assigned to a user that is not the main user assigned to the main account linked to the virtual user account (that is linked to the sub-virtual user account) and/or the user assigned to the virtual user account linked to the sub-virtual user account. It is recognized in the present disclosure that the sub-virtual user account may be assigned to a user at any time (e.g., immediately upon creating the sub-virtual user account or at a later stage, such as after linking the sub-virtual user account to a virtual transaction instrument). The configuring of the plurality of sub-virtual user accounts may also include linking each sub-virtual user account to one or more of the virtual user accounts (e.g., a virtual user account created in action 222). For example, sub-virtual user accounts assigned or not assigned to users may be linked to a virtual user account and/or a main account assigned to a main user (e.g., distributor, aggregator, etc.). The configuring of the plurality of sub-virtual user accounts may also include routing deposits made to each sub-virtual user account to one or more of the virtual user accounts and/or one or more of the main accounts (e.g., action 228). For example, requests or instructions to deposit funds into sub-virtual user accounts assigned to users (e.g., retailers, travel agents) may be directly routed and/or deposited into virtual user account linked to the sub-virtual user account and/or the main account assigned to a main user (e.g., distributor, aggregator, etc.) when such sub-virtual user accounts are linked to such virtual user account and/or main account, respectively. As described in the present disclosure, the depositing of funds by users (e.g., retailers, travel agents) into their own sub-virtual user accounts may be considered as a deposit, pre-payment, funding, filling, and/or topping-up of their virtual transaction instruments (e.g., virtual payment card such as a virtual debit card or virtual credit card).

Configuring a Plurality of Virtual Transaction Instruments (e.g., Action 230).

In an example embodiment, the method 200 of processing and/or managing transaction requests may include configuring a plurality of virtual transaction instruments (e.g., action 230). The configuring of the plurality of virtual transaction instruments 230 may be performable by example embodiments of a system for processing transaction requests (e.g., system 700 illustrated in at least FIG. 7). For example, the configuring of the plurality of virtual transaction instruments 230 may be performable by an example embodiment of the configurator (e.g., configurator 710). As described above and in the present disclosure, each virtual transaction instrument may be a virtual payment card (e.g., virtual debit card, virtual credit card, virtual top-up card, private label payment card, etc.) linked to one or more of the virtual user accounts. Alternatively, each virtual transaction instrument may be a virtual payment card (e.g., virtual debit card, virtual credit card, virtual top-up card, private label payment card, etc.) linked to one or more sub-virtual user accounts. As described above and in the present disclosure, each virtual transaction instrument may be assigned to one or more users. The terms “virtual transaction instrument” and “virtual payment card” may be used interchangeably in the present disclosure. Each virtual transaction instrument may have its own account number (which may or may not be the same as the account number of the virtual user account or sub-virtual user account that is linked to the virtual transaction instrument), balance (which may or may not have the same balance as the virtual user account or sub-virtual user account), tracking of transaction history, etc.

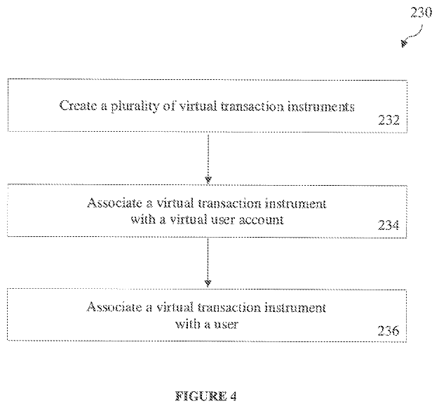

As illustrated in at least FIG. 4, the configuring of the plurality of virtual transaction instruments 230 may include creating a plurality of virtual transaction instruments (e.g., action 232). For example, an entity having virtual debit card or credit card issuing, creating, and/or opening capabilities (e.g., an issuer) or an entity that instructs an entity having virtual debit card or credit card issuing, creating, and/or opening capabilities may perform the creating of a plurality of virtual transaction instruments (e.g., action 232). The configuring of the plurality of virtual transaction instruments 230 may also include linking a virtual transaction instrument to a virtual user account (e.g., action 234). For example, each virtual transaction instrument created in action 232 may be linked to one or more of the virtual user accounts configured in action 220. It is recognized in the present disclosure that a virtual transaction instrument created in action 232 may be linked to one or more virtual user accounts that have either been assigned or not yet assigned to a user. Alternatively or in addition, the configuring of the plurality of virtual transaction instruments 230 may also include linking a virtual transaction instrument to a sub-virtual user account. It is recognized in the present disclosure that a virtual transaction instrument created in action 232 may be linked to one or more virtual user accounts and/or one or more sub-virtual user accounts that have either been assigned or not yet assigned to a user. The configuring of the plurality of virtual transaction instruments 230 may also include assigning a virtual transaction instrument to a user (e.g., action 236). For example, each virtual transaction instrument created in action 232 and linked in action 234 may be assigned to one or more users. The user(s) assigned to the virtual transaction instrument may or may not be the same user(s) assigned to the one or more virtual user accounts (or sub-virtual user accounts) that are linked to the virtual transaction instrument. It is recognized in the present disclosure that the assigning of the user(s) to virtual user account(s) (or sub-virtual user account(s)) and virtual transaction instrument(s) linked to such virtual user account(s) (or sub-virtual user account(s)) may be performed at the same time or at different times.

Receiving a Request for Authorization of a Payment Request (e.g., Action 240).

In an example embodiment, the method 200 of processing and/or managing transaction requests may include receiving a request for authorization of a payment request (e.g., action 240). The receiving of requests for authorization of payment requests 240 may be performable by example embodiments of a system for processing transaction requests (e.g., system 700 illustrated in at least FIG. 7). For example, the receiving of requests for authorization of payment requests 240 may be performable by an example embodiment of the aggregator (e.g., aggregator 730) and/or authorizer (e.g., authorizer 750). Requests for authorization of payment requests may be communicated via a communication channel. For example, a communication channel may be established between the system 700 (e.g., aggregator 730 and/or authorizer 750) and the transaction platform 1. Each request for authorization may be a request to authorize a payment request made using one or more of the virtual transaction instruments (e.g., an example embodiment of the one or more virtual transaction instruments configured in action 230). Put differently, each request for authorization may occur when a user (e.g., travel agent) uses a virtual transaction instrument (e.g., a virtual debit card) to conduct a transaction (e.g., payment request) via the transaction platform (e.g., a GDS). For such a transaction, a request for authorization may be sent to the system 700 (e.g., authorizer 750 and/or aggregator 730) or processor thereof. Such system 700 may be configurable or configured to check, among other things, whether the virtual transaction instrument is authorized to conduct the transaction, whether the virtual transaction instrument is restricted from conducting certain types of transactions, whether further checks and/or information are required to process an authorization, whether the virtual transaction instrument is linked to one or more virtual user accounts and/or sub-virtual user accounts, whether one or more virtual user accounts and/or sub-virtual user accounts linked to the virtual transaction instrument has sufficient funds (i.e., sufficient unused balance of the virtual user account and/or sub-virtual user account) to complete/cover the payment request, whether the virtual transaction instrument has a limit (e.g., credit limit, overdraft, etc.), etc.

The request for authorization may be received and/or processed in one or more of a plurality of ways. For example, in a situation where the virtual transaction instrument is a virtual debit card issued by a card association (e.g., VISA®, MASTERCARD®, American Express, Diners Club, etc.), the request for authorization may first be received, managed, and/or processed, in part or in whole, by an authorization system of such card association. It is recognized in the present disclosure that such authorization system may be configured, requested, and/or instructed to identify requests for authorization that are received for payment requests made using example embodiments of virtual transaction instruments described above and in the present disclosure. Such authorization systems may then be configured, requested, and/or instructed to send, route, and/or divert such requests for authorizations to example embodiments of system 700, as described in the present disclosure. In this regard, the system 700 may then perform an authorization process on such requests for authorizations, as further described below and in the present disclosure.

A request for authorization of a payment request may be sent by any entity, including those responsible for receiving and/or processing transactions made via the transaction platform 1 (e.g., the provider 3, the owner, operator, and/or representative of the transaction platform, representative of one or more of the aforementioned entities; etc.).

Performing an Authorization Process (e.g., Action 250).

In an example embodiment, the method 200 of processing and/or managing transaction requests may include performing an authorization process (e.g., action 250). The authorization process 250 may be performable by example embodiments of a system for processing transaction requests (e.g., system 700 illustrated in at least FIG. 7). For example, the authorization process 250 may be performable by an example embodiment of the authorizer (e.g., authorizer 750), aggregator (e.g., aggregator 730), recorder (e.g., recorder 740), and/or transactor (e.g., transactor 720). The authorization process 250 may be performable in response to receiving a request to authorize a payment request 240 (e.g., as described in action 240).

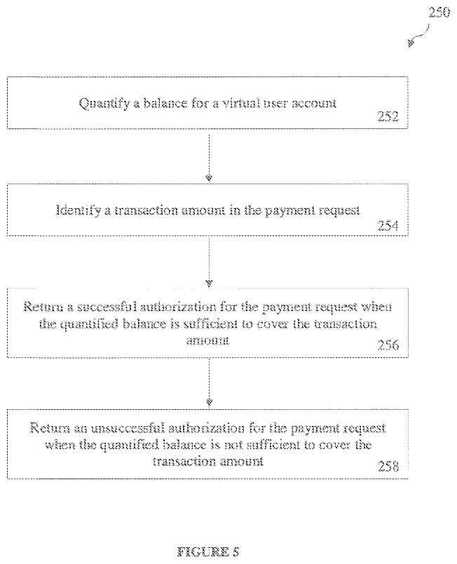

As illustrated in at least FIG. 5, the authorization process 250 may include quantifying or determining a balance for a virtual user account 252. Alternatively or in addition, the authorization process 250 may include quantifying or determining a balance for a sub-virtual user account. The quantifying or determining of a balance for a virtual user account 252 (and/or sub-virtual user account) may include quantifying and/or determining a limit (e.g., a preset limit, credit limit, overdraft limit, etc.) for the virtual transaction instrument used to make the payment request. Alternatively, the quantifying or determining of a balance for a virtual user account 252 (and/or sub-virtual user account) may not involve quantifying or determining a balance of a virtual user account (and/or sub-virtual user account), but instead involve quantifying and/or determining a limit for the virtual transaction instrument linked to the virtual user account (and/or sub-virtual user account). The quantifying or determining of a balance for a virtual user account 252 (and/or sub-virtual user account) may be performable by example embodiments of the authorizer (e.g., authorizer 750), recorder (e.g., recorder 740), aggregator (e.g., aggregator 730), and/or database (e.g., database 752). The quantified and/or determined balance may be a real-time, near real-time, or non-real-time balance. To quantify or determine the balance for a virtual user account (and/or limit for the virtual transaction instrument) and/or sub-virtual user account, the method 200 may need to perform one or more actions. For example, when a request to authorize a payment request is received (e.g., action 240), the method 200 may identify the virtual transaction instrument (e.g., account number, user(s), expiry date, issue date. etc. of virtual debit card or virtual credit card) used to make the payment request. Information of the virtual transaction instrument used to make the payment request may be included in the received request for authorization. The method 200 may also identify the virtual user account (and/or sub-virtual user account) linked to the virtual transaction instrument used to make the payment request. In an example embodiment, a table (e.g., look-up table or routing table), chart, or the like stored on a database (e.g., database 752) may be used to look up associations and links between virtual user accounts, sub-virtual user accounts, virtual transaction instruments, users, and/or other information. In some embodiments, the information used to identify the virtual transaction instrument (e.g., account number or other indicia for the virtual debit card or virtual credit card) may be the same as or different from the information used to identify the virtual user account and/or sub-virtual user account. For example, the virtual user account (and/or sub-virtual user account) and virtual transaction instrument may be configured in such a way that the account number of the virtual transaction instrument is the same as the account number of the virtual user account (and/or sub-virtual user account) linked to the virtual transaction instrument. Alternatively, the virtual user account (and/or sub-virtual user account) and virtual transaction instrument may be configured in such a way that the account number of the virtual transaction instrument is a part of the account number of the virtual user account (and/or sub-virtual user account) linked to the virtual transaction instrument. Alternatively, the virtual user account (and/or sub-virtual user account) and virtual transaction instrument may be configured in such a way that the account number of the virtual user account (and/or sub-virtual user account) is a part of the account number of the virtual transaction instrument linked to the virtual user account (and/or sub-virtual user account). Alternatively, the virtual user account (and/or sub-virtual user account) and virtual transaction instrument may be configured in such a way that the account number of the virtual transaction instrument and the account number of the virtual user account (and/or sub-virtual user account) linked to the virtual transaction instrument are related to and/or derivable from one another. Alternatively, the virtual user account (and/or sub-virtual user account) and virtual transaction instrument may be configured in such a way that the account number of the virtual transaction instrument and the account number of the virtual user account (and/or sub-virtual user account) are not related to or derivable from one another. Once the virtual user account (and/or sub-virtual user account) linked to the virtual transaction instrument is identified, the balance for the virtual user account (and/or sub-virtual user account) may be quantified or determined. Alternatively or in addition, once the virtual transaction instrument is identified, the balance (i.e., limit) for the virtual transaction instrument may be quantified or determined. The quantifying or determining of a balance for a virtual user account, sub-virtual user account, and/or virtual transaction instrument 252 may also include identifying a currency of the balance and/or limit.

The authorization process 250 may also include identifying a transaction amount in the payment request 254. The identifying of the transaction amount in the payment request 254 may be performable by example embodiments of the authorizer (e.g., authorizer 750) and/or aggregator (e.g., aggregator 730). The transaction amount for the payment request may be included in the received request for authorization. The identifying of the transaction amount in the payment request 254 may also include identifying a currency of the transaction amount in the payment request. In an example embodiment where the currency of the transaction amount is different from the currency of the balance and/or limit, the authorization process 250 may also include processing the identified transaction amount so as to arrive at an equivalent transaction amount in the currency of the balance and/or limit. Such processing may include retrieving a foreign exchange rate between the currency of the transaction amount and the currency of the balance and/or limit. For example, in a situation where the currency of the balance and/or limit (i.e., currency of the virtual user account, sub-virtual user account, and/or virtual transaction instrument) is in Singapore Dollars (SGD) and the currency of the transaction amount (i.e., currency of the payment request) is in US Dollars (USD), the processing may include converting the transaction amount from USD to SGD.

The authorization process 250 may also include returning a successful authorization for the payment request 256. The returning of a successful authorization for a payment request may be performable by example embodiments of the authorizer (e.g., authorizer 750), aggregator (e.g., aggregator 730), database (e.g., database 752), recorder (e.g., recorder 740), and/or transactor (e.g., transactor 720). In an example embodiment, a successful authorization for a payment request may be returned when the quantified or determined balance and/or limit (action 252) is determined to be sufficient to cover the identified transaction amount (action 254). For example, if the quantified or determined balance and/or limit is determined to be greater than or equal to the transaction amount in the payment request, then the authorization process 250 may return a successful authorization. The successful authorization may be returned (e.g., transmitted), by the system (e.g., by the authorizer 750 and/or aggregator 730), to the entity that sent the authorization request (e.g., the transaction platform 707). When the authorization process 250 successfully authorizes a payment request, the authorization process 250 may also include recording a deduction in the virtual user account (and/or sub-virtual user account). The deduction may be equal to the transaction amount (as identified in action 254). It is to be understood that the deduction recorded in the virtual user account (and/or sub-virtual user account) may be more or less than the transaction amount. For example, the deduction recorded in the virtual user account (and/or sub-virtual user account) may be more than the transaction amount when service fees, transaction fees, taxes, duties, and/or other surcharges need to be included. As another example, the deduction recorded in the virtual user account (and/or sub-virtual user account) may be less than the transaction amount when discounts, promotions, etc. need to be included. Other factors, fees, adjustments, etc. are contemplated in the present disclosure that may also cause the deduction recorded in the virtual user account (and/or sub-virtual user account) to be different from the transaction amount.

The authorization process 250 may also include returning an unsuccessful authorization for the payment request. The returning of an unsuccessful authorization for a payment request may be performable by example embodiments of the authorizer (e.g., authorizer 750), aggregator (e.g., aggregator 730), database (e.g., database 752), recorder (e.g., recorder 740), and/or transactor (e.g., transactor 720). In an example embodiment, an unsuccessful authorization for a payment request may be returned when the quantified and/or determined balance and/or limit (as quantified in action 252) is determined to be insufficient to cover the identified transaction amount (as identified in action 252). For example, if the quantified and/or determined balance and/or limit is found to be less than the transaction amount in the payment request, then the authorization process 250 may return an unsuccessful authorization. The unsuccessful authorization may be returned, by the system (e.g., the authorizer 750 and/or aggregator 730), to the entity that sent the authorization request (e.g., the transaction platform 707). When the authorization process 250 does not successfully authorize a payment request, the authorization process 250 may also include not recording a deduction in the virtual user account (and/or sub-virtual user account). The authorization process may also include recording a note in the virtual user account (and/or sub-virtual user account) regarding the unsuccessful authorization (e.g., details of the authorization request and the insufficiency of funds). The authorization process may also include recording a charge (e.g., non-sufficient funds or NSF charge) in the virtual user account (and/or sub-virtual user account).

Performing a Reconciliation Process (e.g., Action 260).

In an example embodiment, the method 200 may include performing a reconciliation process (e.g., action 260). The reconciliation process 260 may be performable by example embodiments of a system for processing transaction requests (e.g., system 700 illustrated in at least FIG. 7). For example, the reconciliation process 260 may be performable by an example embodiment of the reconciler (e.g., reconciler 760), aggregator (e.g., aggregator 730), transactor (e.g., transactor 720), and/or authorizer (e.g., authorizer 750). The reconciliation process 260 may be performable in response to a receiving of an authorization report. For example, after a certain period of time (e.g., hourly, daily, weekly, etc.), the transaction platform (e.g., transaction platform 707) or other entity (e.g., an entity that sends authorization requests and receives results of authorization requests) may collect some or all payment requests that received successful authorizations from the authorization process 250 (e.g., all successfully authorized payment requests that were returned by the system (e.g., authorizer 750)) and create and send an authorization report listing such payment requests.

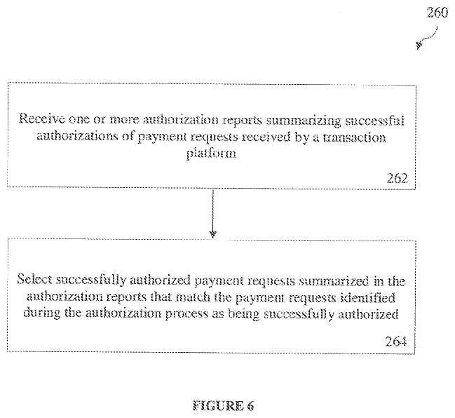

As illustrated in at least FIG. 6, the reconciliation process 260 may include receiving one or more authorization reports summarizing successful authorizations of payment requests made via the transaction platform (e.g., action 262). The receiving of the one or more authorization reports may be performable by the aggregator (e.g., aggregator 730) and/or the reconciler (e.g., reconciler 760). The reconciliation process 260 may also retrieve records (e.g., results or summaries from the authorization process 250) of payment requests identified during the authorization process 250 as being successfully authorized. The reconciliation process 260 may also perform a verification, check, and/or comparison of the successfully authorized payment requests summarized in the authorization reports with the payment requests identified during the authorization process 250 as being successfully authorized (i.e., the retrieved records). Put simply, the reconciliation process 260 may perform a check as to whether the authorization reports provided by transaction platform 707 match the internally recorded successfully authorized payment requests. The reconciliation process 260 may then select successfully authorized payment requests summarized in the authorization reports that match the payment requests identified during the authorization process as being successfully authorized (e.g., action 264).

Performing a Settlement Process (e.g., Action 270).

In an example embodiment, the method 200 may include performing a settlement process (e.g., action 270). The settlement process 270 may be performable by example embodiments of a system for processing transaction requests (e.g., system 700 illustrated in at least FIG. 7). For example, the settlement process 270 may be performable by an example embodiment of the transactor (e.g., transactor 720), reconciler (e.g., reconciler 760), authorizer (e.g., authorizer 750), and/or recorder (e.g., recorder 740).

In an example embodiment, the settlement process 270 may be performable in response to the reconciliation process 260. For example, after the reconciler 760 selects the successfully authorized payment requests summarized in the authorization reports that match the payment requests identified during the authorization process as being successfully authorized, the settlement process 270 may perform a settlement of such matching payment requests. The settlement process 270, which may be performed by the transactor 720, may include transferring or causing a transfer of funds to pay for the payment requests selected by the reconciliation process 260.

In performing the settlement process 270, one or more main accounts (e.g., main account 701) that received deposits from the virtual user accounts (e.g., from action 228) and/or sub-virtual user accounts may be used to perform the transferring of funds to pay for the payment requests selected by the reconciliation process 260. For example, the provider (e.g., provider 706) in each payment request selected by the reconciliation process 260 may be identified and a transfer of funds from main account 701 to such provider equal to the transaction amount in such selected payment request may be performed. Alternatively, the main account 701 may transfer payment to the transaction platform 707 equal to the sum of all transaction amounts of all selected payment requests (in which case, the transaction platform 707 may be responsible for further settling with the vendors 706).

Alternatively or in addition, the main user 702 may have a first main account and a second main account. The first main account may be configurable or configured to receive deposits from the virtual user accounts (e.g., from action 228) and/or sub-virtual user accounts. The first main account may receive instructions from the transactor 720 and/or reconciler 760 to transfer funds to the second main account equal to the sum of all transaction amounts of all selected payment requests (as selected by the reconciliation process 260). The second main account may then be used to perform the transferring of funds to pay for the payment requests selected by the reconciliation process 260. For example, the provider (e.g., provider 706) in each payment request selected by the reconciliation process 260 may be identified and a transfer of funds from the second main account to such provider equal to the transaction amount in such selected payment request may be performed (after at least such amount of funds are transferred from the first main account to the second main account). In this example embodiment, the first main account may be responsible for receiving deposits from users via their virtual user accounts (and/or sub-virtual user accounts) and supplying funds to the second main account when settlement is required, and the second main account may be responsible for performing settlement of the payment requests selected by the reconciliation process 260. Other example embodiments, including other configurations of main accounts, are contemplated without departing from the teachings of the present disclosure.

Other example embodiments and/or variations of the method (e.g., method 200) of processing and/or managing communication requests are also contemplated without departing from the teachings of the present disclosure. For example, in situations where the one or more main accounts (e.g., main account 701) and/or one or more virtual user accounts (e.g., virtual user account 703) (and/or one or more sub-virtual user accounts) are provided by one or more financial institutions (e.g., a financial institution 9 illustrated in FIG. 1), or the like, the one or more financial institutions may have a direct and/or indirect integration, connection (e.g., via a communication channel), and/or association to the transaction platform (e.g., transaction platform 707, such as an ordering, ticketing, and/or booking system). In such situations, one or more virtual user accounts (e.g., virtual user account 703) and/or sub-virtual user accounts may be created and/or assigned to one or more users (e.g., user 704), as described above and in the present disclosure. Such virtual user accounts (and/or sub-virtual user accounts) may be configurable or configured to link to the one or more main accounts, as described above and in the present disclosure. Such virtual user accounts (and/or sub-virtual user accounts) may also be configurable or configured to direct or route deposits made to the virtual user account (and/or sub-virtual user accounts) directly to one or more of the main accounts, as described above and in the present disclosure. One or more virtual transaction instruments (e.g., virtual transaction instrument 705) may also be created and/or linked to one or more of the virtual user accounts (and/or sub-virtual user accounts), and such one or more virtual transaction instruments may also be assigned to one or more users, as described above and in the present disclosure.

Alternatively or in addition, example embodiments of the method (e.g., method 200) of processing and/or managing communication requests may include setting and/or tracking one or more transaction limits (e.g., limit per transaction, limit per type of transaction, limit per provider, daily limit, weekly limit, monthly limit, limit based on funds deposited into the virtual user account and/or sub-virtual user account, credit limit, etc.) for the one or more virtual user accounts, sub-virtual user accounts, and/or virtual transaction instruments. Such transaction limits may be set and/or tracked on the financial institution side and/or the transaction platform side. Such transaction limits may also be viewable and/or adjusted/set by each user. It is to be understood in the present disclosure that double spending, spending more than the amount of funds deposited and/or available, and/or making of one or more transactions that exceed one or more transaction limits may be addressed, avoided, and/or prevented in example embodiments by tracking in real-time or near real-time all communication requests (or transaction requests, payment requests, authorization requests, etc.), along with other information such as applicable transaction limits, time-stamps, digital signatures, account information, status(es) of such requests, transaction amounts, etc., and/or continuously updating and tracking balances and/or transaction limits. Such example embodiments may be performable by example embodiments of the system (e.g., system 700), and performed in one or more of a plurality of ways, such as via distributed ledger technology (e.g., blockchain, etc.).

In some example embodiments, transactions may be conducted via the transaction platform without the use (or direct use) of virtual transaction instruments. For example, an example embodiment of the method (e.g., method 200) of processing and/or managing communication requests may include assigning a specific user transaction ID, or the like, to one or more users. Such specific user transaction ID may be linked to one or more virtual user accounts (and/or sub-virtual user accounts) assigned to the user (e.g., the specific user transaction ID may correspond, include, or be a part of an account number of the virtual user account and/or sub-virtual user account). Alternatively or in addition, such specific user transaction ID may be linked to one or more virtual transaction instruments assigned to the user (e.g., the specific user transaction ID may correspond, include, or be a part of an account number of the virtual transaction instrument). Alternatively or in addition, such specific user transaction ID may be linked to one or more non-virtual accounts (e.g., a traditional bank account) assigned to the user. Alternatively or in addition, such specific user transaction ID may be linked to one or more non-virtual transaction instruments (e.g., a traditional credit card or debit card). Such transactions may be processed, approved, authorized, reconciled, and/or settled in one or more of a plurality of ways, including those described above and in the present disclosure. For example, such transactions may be conducted so long as the transaction limits and/or balances of the virtual user account, sub-virtual user account, virtual transaction instrument, non-virtual account, and/or non-virtual transaction instrument, each as applicable, linked to the specific user transaction ID are sufficient to cover the transaction amount in such transactions. It is recognized in the present disclosure that example embodiments may enable transactions conducted via the transaction platform to occur with or without the use and/or involvement of conventional processes, entities, and/or methods (e.g., without the need to involve authorization processes of card associations, etc.). As mentioned above, in addition to or in replacement of virtual user accounts (and/or sub-virtual user accounts), one or more users may also have non-virtual accounts (e.g., bank accounts, etc.) and/or non-virtual transaction instruments (e.g., credit card or debit card) that are linked to and/or associated with one or more of the main account, in which case the one or more financial institutions (e.g., financial institution of the non-virtual account of the user, financial institution of the main account, intermediary, etc.) may transfer funds from such non-virtual accounts and/or non-virtual transaction instruments to the main account when or after transactions are conducted via the transaction platform.

In another example embodiment, the method of processing and/or managing communication requests may include identifying one or more main accounts for one or more main users (e.g., action 210), configuring one or more virtual user accounts for one or more users (e.g., action 220), configuring one or more sub-virtual user accounts for one or more users, and/or configuring one or more virtual transaction instruments (e.g., action 230), as described above and in the present disclosure. In addition to or in replacement of directing or routing deposits (made by users) to virtual user accounts (and/or sub-virtual user accounts) directly to one or more of the main accounts, as described above and in the present disclosure, example embodiments may be configurable or configured to enable one or more main users to make fund transfers (e.g., deposits, payments, transfers, rebates, incentives, discounts, credit, advances, etc.) to one or more virtual user accounts (and/or one or more sub-virtual user accounts and/or one or more virtual transaction instruments) of one or more users. For example, such funds to be transferred from the main account to one or more virtual user accounts (and/or sub-virtual user accounts and/or one or more virtual transaction instruments) may be sourced from and/or directly deposited to one or more of the main accounts of the main user. More specifically, such fund transfers to the one or more virtual user accounts (and/or one or more sub-virtual user accounts and/or one or more virtual transaction instruments) may be considered as being “virtual transfers” in the sense that the fund transfers will be reflected and updated in the balance and transaction history of such virtual user account (and/or sub-virtual user account), but the actual funds may remain and/or be deposited into one or more of the main accounts. In such an example embodiment, a user may transact (e.g., via the transaction platform) using such funds in the user's virtual user account (and/or sub-virtual user account) that are virtually transferred from one or more main accounts by using one or more virtual transaction instruments linked to the virtual user account (and/or sub-virtual user account). In such case, funds for such transactions will actually come from funds that are in the one or more main accounts. In addition to or in replacement, users may also withdraw and/or transfer such funds in the user's virtual user account (and/or sub-virtual user account) that are virtually transferred from the main account, such as via a virtual or non-virtual transaction instrument at an automatic teller machine (or ATM), from a branch office of a financial institution, via online banking, and/or via one or more other known fund withdrawal and/or transfer methods (e.g., bank transfer, wire transfer, etc.). In such case, funds for such withdrawals and/or transfers will actually come from funds that are in the one or more main accounts.

It is to be understood in the present disclosure that, in addition to or in replacement of directing or routing deposits (made by users) to sub-virtual user accounts directly to one or more of the virtual user accounts and/or main accounts, as described above and in the present disclosure, example embodiments may be configurable or configured to enable one or more main users to make fund transfers (e.g., deposits, payments, transfers, rebates, incentives, discounts, credit, advances, etc.) to one or more sub-virtual user accounts (and/or one or more virtual transaction instruments) of one or more users. Alternatively or in addition, example embodiments may be configurable or configured to enable one or more users of one or more virtual user accounts to make fund transfers (e.g., deposits, payments, transfers, rebates, incentives, discounts, credit, advances, etc.) to one or more sub-virtual user accounts (and/or one or more virtual transaction instruments) of one or more users.

Other example embodiments and/or variations of the method (e.g., method 200) of processing and/or managing communication requests are also contemplated without departing from the teachings of the present disclosure.

Example Embodiments of a System for Processing and/or Managing Transaction Requests (e.g., System 700).

As an overview, an example embodiment of a system or processor (e.g., system 700) for managing and/or processing transaction requests, as described above and in the present disclosure, is illustrated in FIG. 7 and FIG. 8. The system 700 may be configurable or configured to perform one or more of a plurality of functions, operations, actions, methods, and/or processes, including those described above and in the present disclosure. As a non-limiting example, the system 700 may be configurable or configured to perform a registration process for users (e.g., users 704). Such registration process may be for users to participate, use, and/or transact in, through, and/or via one or more transaction platforms (e.g., transaction platform 1). As another example, the system 700 may be configurable or configured to perform a registration process for providers (e.g., providers 706). Such registration process may be for providers to participate, use, and/or transact in, through, and/or via one or more transaction platforms (e.g., transaction platform 1). As another example, the system 700 may be configurable or configured to perform a registration process for one or more main users (e.g., main user 702). Such registration process may be for one or more main users to agree to front and/or advance payment and/or other forms of value on behalf of users for transactions conducted between such users and one or more providers via one or more transaction platforms (e.g., transaction platform 1). As another example, the system 700 may be configurable or configured to identify one or more main accounts (e.g., main accounts 701) (e.g., action 210), as described in the present disclosure. As another example, the system 700 may be configurable or configured to configure a one or more virtual user accounts (e.g., virtual user accounts 703) (e.g., action 220), as described in the present disclosure. As another example, the system 700 may be configurable or configured to configure a one or more sub-virtual user accounts, as described in the present disclosure. As another example, the system 700 may be configurable or configured to configure a plurality of virtual transaction instruments (e.g., virtual payment cards 705) (e.g., action 230), as described in the present disclosure. As another example, the system 700 may be configurable or configured to receive a request for authorization of a payment request made via a transaction platform (e.g., transaction platform 707) (e.g., action 240), as described in the present disclosure. As another example, the system 700 may be configurable or configured to perform an authorization process (e.g., action 250), as described in the present disclosure. As another example, the system 700 may be configurable or configured to perform a reconciliation process (e.g., action 260), as described in the present disclosure. As another example, the system 700 may be configurable or configured to perform a settlement process (e.g., action 270), as described in the present disclosure.

As used in the present disclosure, when applicable, a reference to a system or processor may also refer to, apply to, and/or include a computing device, processor, server, system, cloud-based computing, or the like, and/or functionality of a processor, computing device, server, system, cloud-based computing, or the like. The system 700 (and/or its elements, as described in the present disclosure) may be any processor, server, system, device, computing device, controller, microprocessor, microcontroller, microchip, semiconductor device, or the like, configurable or configured to perform, among other things, a processing and/or managing of information, data and/or voice communications, and/or other actions described above and in the present disclosure. Alternatively or in addition, the system 700 (and/or its elements, as described in the present disclosure) may include and/or be a part of a virtual machine, processor, computer, node, instance, host, or machine, including those in a networked computing environment. As used in the present disclosure, such a network and/or cloud may be a collection of devices connected by communication channels that facilitate communications between devices and allow for devices to share resources. Such resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof. A network or cloud may include, but is not limited to, computing grid systems, peer to peer systems, mesh-type systems, distributed computing environments, cloud computing environment, etc. Such network or cloud may include hardware and software infrastructures configured to form a virtual organization comprised of multiple resources which may be in geographically disperse locations. Network may also refer to a communication medium between processes on the same device. Also as referred to herein, a network element, node, or server may be a device deployed to execute a program operating as a socket listener and may include software instances.

The system 700 may be configurable or configured to communicate with one or more user computing devices (e.g., computing device used by users 704 to transact, including receiving deposits and/or submit payment requests via transaction platforms 707 using virtual payment cards 705). The system 700 may also be configurable or configured to communicate with one or more provider computing devices (e.g., computing device used by providers 706 to transact and/or agree with payment requests submitted via transaction platforms 707 using virtual payment cards 705). The system 700 may also be configurable or configured to communicate with one or more main user computing devices (e.g., computing device used by main users 702 to perform, among other things, reconciliation processes (e.g., action 260), settlement processes (e.g., 270), etc.). The system 700 may also be configurable or configured to communicate with one or more transaction platforms (e.g., transaction platform 707) and/or databases (e.g., database 752). For example, the system 700 may be configurable or configured to establish a communication channel with the transaction platform 707 and/or database 752. The system 700, databases 752, user computing devices, provider computing devices, and/or main user computer devices may be in communication with one another via one or more networks, such as the Internet, World Wide Web, one or more private networks, the cloud, or the like.

In an example embodiment, the system 700 may include one or more configurators (e.g., configurator 710). The system 700 may also include one or more transactors (e.g., transactor 720). The system 700 may also include one or more aggregators (e.g., aggregator 730). The system 700 may also include one or more recorders (e.g., recorder 740). The system 700 may also include one or more authorizers (e.g., authorizer 750). The system 700 may also include one or more reconcilers (e.g., reconciler 760). The system 700 may also include one or more databases (e.g., database 752). As used in the present disclosure, when and where applicable, a reference to a database may also refer to, apply to, and/or include database systems, database management systems, cloud-based computing, cloud-based storage, storage systems and devices, distributed ledger-related technologies and system, blockchain-related technologies and systems, or the like.

Example embodiments of the system 700 may include, not include, communicate with, and/or not communicate with one or more of the elements described above and in the present disclosure, may include and/or communicate with additional elements, may include and/or communicate with equivalent elements, may be formed, implementable/implemented, and/or used in different sequences, actions, combinations, and/or configurations, and/or one or more of the elements (and/or elements of elements) may be combinable into a single element and/or divided into two or more elements. It is also to be understood in the present disclosure that one or more functionalities, actions, methods, and/or processes performed or performable by one or more of the elements described above and in the present disclosure may be implemented or implementable, directly or indirectly, using or via one or more other elements or ways, such as via cloud computing, parallel, collaborative, and/or distributed computing or processing, distributed ledger technology (DLT), or the like. Communication using technologies other than the Internet are also contemplated in example embodiments without departing from the teachings of the present disclosure. The system 700, and elements and functionality thereof, will now be further described with reference to the accompanying figures and actions and methods (e.g., method 200, as illustrated in FIGS. 2-6) described in the present disclosure.

User Computing Device.

In an example embodiment, the system 700 may be configurable or configured to communicate, directly or indirectly, with one or more user computing devices of users 704. A user computing device may be any device, computing device, mobile computing device, processor, controller, or the like, configurable or configured to perform a processing of information, communicate via wired and/or wireless communications, and/or any of the other actions, processes, and/or functionalities described above and in the present disclosure. For example, the user computing device may be configurable or configured to perform wireless communications through 3G networks, 4G networks, 4G LTE networks, or the like, such as via a SIM card installed in the user computing device, or the like. In addition to or alternatively, the user computing device may be configurable or configured to perform wireless communications via WLANs, such as Wi-Fi networks and Li-Fi networks, and/or via other forms, such as Bluetooth, NFC, sound (e.g., Google Nearby), and other forms of wireless signals. One or more of the aforementioned communications may be between example embodiments of the user computing device, provider computing device, system 700 or processor 700, transaction platform 707, and/or one or more networks.

In an example embodiment, the user computing device may be configurable or configured (e.g., via software, such as a mobile application, installed on the user computing device) to perform, among other things, transaction requests (e.g., payment requests) via one or more transaction platforms 707. For example, the user computing device may be configurable or configured to search, view, review, and select an offering (e.g., airplane ticket or other goods and/or services) from a provider via a transaction platform 707 and submit a payment request (e.g., confirm transaction) for a desired offering via the transaction platform 707. The user computing device may also be configurable or configured (e.g., via software, such as a mobile application, installed on the user computing device) to receive and/or provide one or more virtual transaction instruments (e.g., virtual payment card 705) when submitting payment requests via the transaction platform 707.

Provider Computing Device.

The system 700 may be configurable or configured to communicate, directly or indirectly, with one or more provider computing devices of providers 706. A provider computing device may be any device, computing device, mobile computing device, processor, controller, or the like, configurable or configured to perform a processing of information, communicate via wired and/or wireless communications, and/or any of the other actions, processes, and/or functionalities described above and in the present disclosure. For example, the provider computing device may be configurable or configured to perform wireless communications through 3G networks, 4G networks, 4G LTE networks, or the like, such as via a SIM card installed in the provider computing device, or the like. In addition to or alternatively, the provider computing device may be configurable or configured to perform wireless communications via WLANs, such as Wi-Fi networks and Li-Fi networks, and/or via other forms, such as Bluetooth, NFC, sound (e.g., Google Nearby), and other forms of wireless signals. One or more of the aforementioned communications may be between example embodiments of the provider computing device, user computing device, system 700, transaction platform 707, and/or one or more networks.

In an example embodiment, the provider computing device may be configurable or configured (e.g., via software, such as a mobile application, installed on the provider computing device) to perform, among other things, receiving and reviewing of transaction requests (e.g., payment requests) sent from user computing devices via transaction platforms 707. For example, the provider computing device may be configurable or configured to provide information (e.g., information on products, services, availability, pricing, terms, conditions, etc.) and accept payment requests (e.g., confirm transaction) submitted, by user computing devices, via the transaction platform 707.

Configurator (e.g., Configurator 710).

The system 700 may include and/or perform one or more functionalities of one or more configurators (e.g., configurator 710). As illustrated in FIG. 8, an example embodiment of the configurator 710 may be configurable or configured to perform a registration process for users (e.g., users 704). Such registration process may be to enable users to participate, use, and/or transact in, through, and/or via one or more transaction platforms (e.g., transaction platform 1). The configurator 710 may also be configurable or configured to perform a registration process for providers (e.g., providers 706). Such registration process may be to enable providers to participate, use, and/or transact in, through, and/or via one or more transaction platforms (e.g., transaction platform 1). The configurator 710 may also be configurable or configured to perform a registration process for main users (e.g., main user 702). Such registration process may be for one or more main users to agree to front and/or advance payment and/or other forms of value on behalf of users for transactions conducted between such users and one or more providers via one or more transaction platforms (e.g., transaction platform 1). The configurator 710 may also be configurable or configured to identify one or more main accounts (e.g., main accounts 701) (e.g., action 210 illustrated in FIG. 2), as described in the present disclosure. The configurator 710 may also be configurable or configured to configure a plurality of virtual user accounts (e.g., virtual user accounts 703) (e.g., action 220), as described in the present disclosure. The configurator 710 may also be configurable or configured to configure a plurality of sub-virtual user accounts, as described in the present disclosure. The configurator 710 may also be configurable or configured to configure a plurality of virtual transaction instruments (e.g., virtual payment cards 705) (e.g., action 230), as described in the present disclosure. The configurator 710 may also be configurable or configured to set, configure, and/or adjust one or more transaction limits, as described above and in the present disclosure. For example, the configurator 710 may be configurable or configured to set, configure, and/or adjust one or more transaction limits for one or more virtual user accounts, as described above and in the present disclosure. The configurator 710 may also be configurable or configured to set, configure, and/or adjust one or more transaction limits for one or more sub-virtual user accounts, as described above and in the present disclosure. The configurator 710 may also be configurable or configured to set, configure, and/or adjust one or more transaction limits for one or more virtual transaction instruments, as described above and in the present disclosure. The configurator 710 may also be configurable or configured to set, configure, and/or adjust one or more transaction limits for one or more non-virtual accounts, as described above and in the present disclosure. The configurator 710 may also be configurable or configured to set, configure, and/or adjust one or more non-virtual transaction instruments, as described above and in the present disclosure.

In an example embodiment, a single configurator 710 may be configurable or configured to perform the functions and operations of the configurator 710 described above and in the present disclosure. Alternatively or in addition, a plurality of configurators 710 may be configurable or configured to perform the functions and operations of the configurator 710.

Transactor (e.g., Transactor 720).

The system 700 may include and/or perform one or more functionalities of one or more transactors (e.g., transactor 720). As illustrated in FIG. 8, an example embodiment of the transactor 720 may be configurable or configured to communicate with the recorder (e.g., recorder 740), authorizer (e.g., authorizer 750), and/or reconciler (e.g., reconciler 760). For example, after the authorizer 750 returns a successful authorization of a payment request (from an authorization request sent from the transaction platform 707) (e.g., action 256), the reconciler 760 may select the successfully authorized payment requests (e.g., action 264) and provide the selected successfully authorized payment requests to the transactor 720. The transactor 720 may then be configurable or configured to transfer or cause a transfer of funds to settle such selected successfully authorized payment requests.

In an example embodiment, after the reconciler 760 selects the successfully authorized payment requests summarized in the authorization reports that match the payment requests identified during the authorization process as being successfully authorized, the settlement process 270 may perform a settlement of such matching payment requests. The settlement process 270, which may be performed by the transactor 720, may include transferring or causing a transfer of funds to pay for the payment requests selected by the reconciliation process 260.

In another example embodiment, the transactor 720 may be configurable or configured to perform fund transfers and/or payments for transactions conducted using specific user transaction IDs, as described above and in the present disclosure. The transactor 720 may also be configurable or configured to perform fund transfers and/or payments in example embodiments where one or more users use funds (e.g., transact, withdraw, and/or transfer) were virtually transferred from one or more main users (e.g., deposits, payments, rebates, incentives, discounts, etc.) to one or more virtual user accounts (and/or one or more sub-virtual user accounts) of one or more users, as described above and in the present disclosure.

In an example embodiment, the transactor 720 may use the main account (e.g., main account 701) that received deposits from the virtual user accounts (e.g., from action 228) and/or sub-virtual user accounts to perform the transferring of funds to pay for the payment requests selected by the reconciliation process 260. For example, the transactor 720 may identify the provider (e.g., provider 706) in each payment request selected by the reconciliation process 260 and transfer payments from the main account 701 to such provider equal to the transaction amount in such selected payment request. Alternatively, the transactor 720 may transfer payment from the main account 701 to the transaction platform 707 equal to the sum of all transaction amounts of all selected payment requests (in which case, the transaction platform 707 may be responsible for further settling with the vendors 706).

In another example embodiment, the main accounts may be configured in such a way that there is a first main account and a second main account. The first main account may be configured to receive deposits from one or more virtual user accounts (e.g., from action 228) and/or one or more sub-virtual user accounts. The transactor 720 may transfer, from the first main account to the second main account, an amount equal to a sum of some or all transaction amounts of all selected payment requests (as selected by the reconciliation process 260). The transactor 720 may then perform the transferring of funds from the second main account to each provider to pay for the payment requests selected by the reconciliation process 260. For example, the transactor 720 may identify the provider (e.g., provider 706) in each payment request selected by the reconciliation process 260 and transfer payments from the second main account to such provider(s) equal to the transaction amount in such selected payment request. In this example embodiment, the first main account may be responsible for receiving deposits from users via their virtual user accounts and/or sub-virtual user accounts and supply funds to the second main account when settlement is required. Furthermore, the second main account may be responsible for performing settlement of the payment requests selected by the reconciliation process 260. Other example embodiments, including other configurations of main accounts, are contemplated without departing from the teachings of the present disclosure.

In an example embodiment, a single transactor 720 may be configurable or configured to perform the functions and operations of the transactor 720 described above and in the present disclosure. Alternatively or in addition, a plurality of transactors 720 may be configurable or configured to perform the functions and operations of the transactor 720.

Aggregrator (e.g., Aggregator 730).

The system 700 may include and/or perform one or more functionalities of one or more aggregators (e.g., aggregator 730). As illustrated in FIG. 8, an example embodiment of the aggregator 730 may be configurable or configured to receive and/or communicate information, including, but not limited to, authorization requests for payment requests made via transaction platforms 707 (e.g., action 240), authorization reports for authorized payment requests made via transaction platforms 707 (e.g., action 262), information for one or more users or registered users 704, information for one or more main users 702, information for one or more identified main accounts 701 (e.g., as identified in action 210), information for one or more configured virtual user accounts 703 (e.g., as configured in action 220) and/or one or more configured sub-virtual user accounts, information for one or more configured virtual transaction instruments 705 (e.g., as configured in action 230), information for one or more specific user transaction IDs, information from one or more transaction platforms 707, information stored on one or more databases 752, information from the authorizer 750 (e.g., authorization requests for payment requests), information to the reconciler 760 (e.g., authorization reports), information to the recorder 740 (e.g., to update virtual user accounts and/or sub-virtual user accounts of successful authorizations and unsuccessful authorizations), information to the configurator 710 (e.g., information on new users 704, new main users 702, new virtual user accounts 703, new sub-virtual user accounts, new virtual transaction instruments 705), information pertaining to balances and/or transaction limits, etc.

In an example embodiment, a single aggregator 730 may be configurable or configured to perform the functions and operations of the aggregator 730 described above and in the present disclosure. Alternatively or in addition, a plurality of aggregators 730 may be configurable or configured to perform the functions and operations of the aggregator 730.

Recorder (e.g., Recorder 740).

The system 700 may include and/or perform one or more functionalities of one or more recorders (e.g., recorder 740). As illustrated in FIG. 8, an example embodiment of the recorder 740 may be configurable or configured to record information pertaining to accounts and transactions. For example, the recorder 740 may be configurable or configured to record authorized payment requests, non-authorized payment requests, transaction details (e.g., deposits, payments, etc.), main account information (e.g., account number, main user assigned to the main account, balance of the main account (and may also include balances of virtual user accounts, sub-virtual user accounts, and/or virtual transaction instruments linked to the main account), transactions, virtual user accounts linked to the main account, sub-virtual user accounts linked to the main account, sub-virtual user accounts linked to virtual user accounts, virtual transaction instruments linked to virtual user accounts (and/or sub-virtual user accounts) that are linked to the main account, etc.), virtual user account and/or sub-virtual user account information (e.g., account number, user assigned to the virtual user account and/or sub-virtual user account, balance of the virtual user account and/or sub-virtual user account (and may also include balance of virtual transaction instruments linked to the virtual user account and/or sub-virtual user account), transactions, virtual transaction instruments linked to the virtual user account and/or sub-virtual user account, etc.), virtual transaction instrument information (e.g., account number, user assigned to the virtual transaction instrument, balance of the virtual transaction instrument (and may also include balance of the virtual user account and/or sub-virtual user account linked to the virtual transaction instrument), transactions, etc.), etc.

The recorder 740 may also be configurable or configured to keep track of and/or record (e.g., in real time and/or near real time) one or more transaction limits, as described above and in the present disclosure. For example, the recorder 740 may be configurable or configured to keep track of one or more transaction limits for one or more virtual user accounts and/or sub-virtual user accounts, as described above and in the present disclosure. The recorder 740 may also be configurable or configured to keep track of one or more transaction limits for one or more virtual transaction instruments, as described above and in the present disclosure. The recorder 740 may also be configurable or configured to keep track of one or more transaction limits for one or more non-virtual accounts, as described above and in the present disclosure. The recorder 740 may also be configurable or configured to keep track of one or more non-virtual transaction instruments, as described above and in the present disclosure.

In an example embodiment, a single recorder 740 may be configurable or configured to perform the functions and operations of the recorder 740 described above and in the present disclosure. Alternatively or in addition, a plurality of recorders 740 may be configurable or configured to perform the functions and operations of the recorder 740.

Authorizer (e.g., Authorizer 750).

The system 700 may include and/or perform one or more functionalities of one or more authorizers (e.g., authorizer 750). As illustrated in at least FIGS. 5 and 8, an example embodiment of the authorizer 750 may be configurable or configured to perform an authorization process. For example, the authorizer 750 may be configurable or configured to communicate with the aggregator 730 to receive requests for authorizations (e.g., see action 240). The authorizer 750 may also be configurable or configured to quantify or determine a balance for a virtual user account 703 (e.g., see action 252) and/or sub-virtual user account. The quantifying or determining of a balance for a virtual user account 703 and/or sub-virtual user account by the authorizer 750 may include quantifying and/or determining a limit (e.g., a preset limit or credit limit) for the virtual transaction instrument 705 used to make the payment request. Alternatively, the quantifying or determining of a balance for a virtual user account 703 and/or sub-virtual user account by the authorizer 750 may not involve quantifying or determining a balance of a virtual user account 703 and/or sub-virtual user account, but instead involve quantifying and/or determining a limit for the virtual transaction instrument 705 linked to the virtual user account 703 and/or sub-virtual user account. The quantified and/or determined balance may be a real-time, near real-time, or non-real-time balance. To quantify or determine the balance for a virtual user account (and/or sub-virtual user account and/or limit for the virtual transaction instrument), the authorizer 750 may need to perform one or more actions. For example, when a request to authorize a payment request is received by the aggregator 730, the authorizer 750 may identify the virtual transaction instrument 705 (e.g., account number, user(s), expiry date, issue date, etc. of virtual debit card or virtual credit card) used to make the payment request. Information of the virtual transaction instrument 705 used to make the payment request may be included in the received request for authorization. The authorizer 750 may also identify the virtual user account 703 and/or sub-virtual user account linked to the virtual transaction instrument 705 used to make the payment request. In an example embodiment, a table (e.g., look-up table or routing table), chart, or the like stored on a database (e.g., database 752) may be used by the authorizer 750 to look up associations and links between virtual user accounts 703, sub-virtual user accounts, virtual transaction instruments 705, users 704, and/or other information. In some embodiments, the information used by the authorizer 750 to identify the virtual transaction instrument 705 (e.g., account number or other indicia for the virtual debit card or virtual credit card) may be the same as or different from the information used to identify the virtual user account 703 and/or sub-virtual user account. For example, the virtual user account 703 (and/or sub-virtual user account) and virtual transaction instrument 705 may be configured in such a way that the account number of the virtual transaction instrument 705 is the same as the account number of the virtual user account 703 (and/or sub-virtual user account) linked to the virtual transaction instrument 705. Alternatively, the virtual user account 703 (and/or sub-virtual user account) and virtual transaction instrument 705 may be configured in such a way that the account number of the virtual transaction instrument 705 is a part of the account number of the virtual user account 703 (and/or sub-virtual user account) linked to the virtual transaction instrument 705. Alternatively, the virtual user account 703 (and/or sub-virtual user account) and virtual transaction instrument 705 may be configured in such a way that the account number of the virtual user account 703 (and/or sub-virtual user account) is a part of the account number of the virtual transaction instrument 705 linked to the virtual user account 703 (and/or sub-virtual user account). Alternatively, the virtual user account 703 (and/or sub-virtual user account) and virtual transaction instrument 705 may be configured in such a way that the account number of the virtual transaction instrument 705 and the account number of the virtual user account 703 (and/or sub-virtual user account) linked to the virtual transaction instrument 705 are related to and/or derivable from one another. Alternatively, the virtual user account 703 (and/or sub-virtual user account) and virtual transaction instrument 705 may be configured in such a way that the account number of the virtual transaction instrument 705 and the account number of the virtual user account 703 (and/or sub-virtual user account) are not related to or derivable from one another.

Once the authorizer 750 has identified the virtual user account 703 (and/or sub-virtual user account) linked to the virtual transaction instrument 705, the balance for the virtual user account 703 (and/or sub-virtual user account) may be quantified or determined by the authorizer 750. Alternatively or in addition, once the authorizer 750 has identified the virtual transaction instrument 705, the balance (i.e., limit) for the virtual transaction instrument 705 may be quantified or determined by the authorizer 750. The quantifying or determining, by the authorizer 750, of a balance and/or limit for a virtual user account 703, sub-virtual user account, and/or virtual transaction instrument 705 may also include identifying a currency of the balance and/or limit.

The authorizer 750 may also identify a transaction amount in the payment request (e.g., action 254). The transaction amount for the payment request may be included in the received request for authorization. The identifying of the transaction amount in the payment request 254 by the authorizer 750 may also include identifying a currency of the transaction amount in the payment request. In an example embodiment where the currency of the transaction amount is different from the currency of the balance and/or limit, the authorizer 750 may also process the identified transaction amount so as to arrive at an equivalent transaction amount in the currency of the balance and/or limit. Such processing may include retrieving a foreign exchange rate between the currency of the transaction amount and the currency of the balance and/or limit. For example, in a situation where the currency of the balance and/or limit (i.e., currency of the virtual user account, sub-virtual user account, and/or virtual transaction instrument) is in Singapore Dollars (SGD) and the currency of the transaction amount (i.e., currency of the payment request) is in US Dollars (USD), the authorizer 750 may perform a converting of the transaction amount from USD to SGD.

The authorizer 750 may also return a successful authorization for the payment request. In an example embodiment, a successful authorization for a payment request may be returned by the authorizer 750 when the quantified or determined balance and/or limit is determined by the authorizer 750 to be sufficient to cover the identified transaction amount. For example, if the quantified or determined balance and/or limit is determined by the authorizer 750 to be greater than or equal to the transaction amount in the payment request, then the authorizer 750 may return a successful authorization. The successful authorization may be returned (e.g., transmitted) by the authorizer 750 to the entity that sent the authorization request (e.g., the transaction platform 707). When the authorizer 750 successfully authorizes a payment request, the authorizer 750 may also communicate and/or instruct the recorder 740 to record a deduction in the virtual user account 703 (and/or sub-virtual user account). The deduction may be equal to the transaction amount (as identified in action 254). It is to be understood that the deduction recorded by the recorder 740 in the virtual user account 703 (and/or sub-virtual user account) may be more or less than the transaction amount. For example, the deduction recorded in the virtual user account 703 (and/or sub-virtual user account) may be more than the transaction amount when service fees, transaction fees, taxes, duties, and/or other surcharges need to be included. As another example, the deduction recorded in the virtual user account 703 (and/or sub-virtual user account) may be less than the transaction amount when discounts, promotions, etc. need to be included. Other factors, fees, adjustments, etc. are contemplated in the present disclosure that may also cause the deduction recorded in the virtual user account 703 (and/or sub-virtual user account) to be different from the transaction amount.

The authorizer 750 may also return an unsuccessful authorization for the payment request. In an example embodiment, an unsuccessful authorization for a payment request may be returned by the authorizer 750 when the quantified and/or determined balance and/or limit is determined by the authorizer 750 to be insufficient to cover the identified transaction amount. For example, if the quantified and/or determined balance and/or limit is found to be less than the transaction amount in the payment request, then the authorizer 750 may return an unsuccessful authorization. The unsuccessful authorization may be returned by the authorizer 750 to the entity that sent the authorization request (e.g., the transaction platform 707). The authorizer 750 (and/or recorder 740) may also record a note in the virtual user account 703 (and/or sub-virtual user account) regarding the unsuccessful authorization (e.g., details of the authorization request and the insufficiency of funds). The authorization process may also include recording a charge (e.g., non-sufficient funds or NSF charge) in the virtual user account 703 (and/or sub-virtual user account).

In an example embodiment, a single authorizer 750 may be configurable to perform the functions and operations of the authorizer 750 described above and in the present disclosure. Alternatively or in addition, a plurality of authorizers 750 may be configurable to perform the functions and operations of the authorizer 750.

Reconciler (e.g., Reconciler 760).

The system 700 may include and/or perform one or more functionalities of one or more reconcilers (e.g., reconciler 760). As illustrated in FIG. 8, an example embodiment of the reconciler 760 may be configurable or configured to communicate with the aggregator 730 to receive one or more authorization reports summarizing successful authorizations of payment requests made via the transaction platform (e.g., see action 262). The reconciler 760 may also retrieve records (e.g., results or summaries from the authorization process 250) of payment requests identified during the authorization process (as performed by the authorizer 750) as being successfully authorized. The reconciler 760 may also perform a verification, check, and/or comparison of the successfully authorized payment requests summarized in the authorization reports with the payment requests identified during the authorization process (as performed by the authorizer 750) as being successfully authorized (i.e., the retrieved records). Put simply, the reconciler 760 may perform a check as to whether the authorization reports received (e.g., from the transaction platform 707) match the internally recorded successfully authorized payment requests. The reconciler 760 may then select successfully authorized payment requests summarized in the authorization reports that match the payment requests identified during the authorization process (as performed by the authorizer 750) as being successfully authorized.

In an example embodiment, the reconciler 760 and transactor 720 may also perform the settlement process (e.g., see action 270). The reconciler 760 and transactor 720 may perform the settlement process upon completion of the reconciliation process. For example, after the reconciler 760 selects the successfully authorized payment requests summarized in the authorization reports that match the payment requests identified during the authorization process as being successfully authorized, the reconciler 760 and transactor 720 may perform a settlement of such matching payment requests. The settlement process may include the transactor 720 transferring or causing a transfer of funds to pay for the payment requests selected by the reconciler 760 during the reconciliation process.

In performing the settlement process, one or more main accounts (e.g., main account 701) that received deposits from the virtual user accounts and/or sub-virtual user accounts may be used to perform the transferring of funds to pay for the payment requests selected by the reconciliation process. For example, the provider (e.g., provider 706) in each payment request selected by the reconciler 760 during the reconciliation process may be identified and a transfer of funds from main account 701 to such provider 706 equal to the transaction amount in such selected payment request may be performed. Alternatively, the main account 701 may transfer payment to the transaction platform 707 equal to the sum of all transaction amounts of all selected payment requests (in which case, the transaction platform 707 may be responsible for further settling with the vendors 706).

Alternatively or in addition, the main user 702 may have a first main account and a second main account. The first main account may be configurable or configured to receive deposits from the virtual user accounts 703 and/or sub-virtual user accounts. The first main account may receive instructions from the transactor 720 and/or reconciler 760 to transfer funds to the second main account equal to the sum of all transaction amounts of all selected payment requests (as selected by the reconciler 760 during the reconciliation process). The second main account may then be used to perform the transferring of funds to pay for the payment requests selected by the reconciler 760 during the reconciliation process. For example, the provider (e.g., provider 706) in each payment request selected by the reconciler 760 during the reconciliation process may be identified and a transfer of funds from the second main account to such provider 706 equal to the transaction amount in such selected payment request may be performed (after at least such amount of funds are transferred from the first main account to the second main account). In this example embodiment, the first main account may be responsible for receiving deposits from users 704 via their virtual user accounts 703 (and/or sub-virtual user accounts) and supplying funds to the second main account when settlement is required, and the second main account may be responsible for performing settlement of the payment requests selected by the reconciler 760 during the reconciliation process. Other example embodiments, including other configurations of main accounts, are contemplated without departing from the teachings of the present disclosure.

In an example embodiment, a single reconciler 760 may be configurable to perform the functions and operations of the reconciler 760 described above and in the present disclosure. Alternatively or in addition, a plurality of reconcilers 760 may be configurable to perform the functions and operations of the reconciler 760.

While various embodiments in accordance with the disclosed principles have been described above, it should be understood that they have been presented by way of example only, and are not limiting. Thus, the breadth and scope of the example embodiments described in the present disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

For example, “communication.” “communicate,” “connection,” “connect,” “call,” “calling,” or other similar terms should generally be construed broadly to mean a wired, wireless, and/or other form of, as applicable, connection between elements, devices, computing devices, telephones, processors, controllers, servers, networks, telephone networks, the cloud, and/or the like, which enable voice and/or data to be sent, transmitted, broadcasted, received, intercepted, acquired, and/or transferred (each as applicable).

As another example, “user,” “candidate user,” “selected user,” “final user,” or similar terms should generally be construed broadly to mean a user, either registered or unregistered, who has been selected by one or more elements of the processor (e.g., processor 150), and such user may be a selected user subject to further processing by one or more elements of the processor or a selected user who will receive an offer (e.g., via a notification) to receive distributed ledger data (e.g., digital tokens, cryptocurrency, etc.).

Also, as referred to herein, a processor, device, computing device, telephone, phone, server, gateway server, communication gateway server, and/or controller, may be any processor, computing device, and/or communication device, and may include a virtual machine, computer, node, instance, host, or machine in a networked computing environment. Also as referred to herein, a network or cloud may be or include a collection of machines connected by communication channels that facilitate communications between machines and allow for machines to share resources. Network may also refer to a communication medium between processes on the same machine. Also as referred to herein, a network element, node, or server may be a machine deployed to execute a program operating as a socket listener and may include software instances.

Database (or memory or storage) may comprise any collection and/or arrangement of volatile and/or non-volatile components suitable for storing data. For example, memory may comprise random access memory (RAM) devices, read-only memory (ROM) devices, magnetic storage devices, optical storage devices, solid state devices, and/or any other suitable data storage devices. In particular embodiments, database may represent, in part, computer-readable storage media on which computer instructions and/or logic are encoded. Database may represent any number of memory components within, local to, and/or accessible by a processor and/or computing device.

Various terms used herein have special meanings within the present technical field. Whether a particular term should be construed as such a “term of art” depends on the context in which that term is used. Such terms are to be construed in light of the context in which they are used in the present disclosure and as one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent.” “substantially during,” “substantially complete.” etc., where “substantially” means that such comparisons, measurements, and timings are practicable to accomplish the implicitly or expressly stated desired result.

Additionally, the section headings and topic headings herein are provided for consistency with the suggestions under various patent regulations and practice, or otherwise to provide organizational cues. These headings shall not limit or characterize the embodiments set out in any claims that may issue from this disclosure. Specifically, a description of a technology in the “Background” is not to be construed as an admission that technology is prior art to any embodiments in this disclosure. Furthermore, any reference in this disclosure to “invention” in the singular should not be used to argue that there is only a single point of novelty in this disclosure. Multiple inventions may be set forth according to the limitations of the claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. A system for processing communication requests submitted via one or more transaction platforms, the system comprising:
a configurator, the configurator configurable to:
identify a plurality of registered users;
identify one or more main accounts for making payments on behalf of the plurality of registered users;
configure a plurality of virtual user accounts, the configuring including linking the plurality of virtual user accounts to one of the main accounts, each virtual user account assigned to one of the plurality of registered users; and
configure a plurality of virtual transaction instruments, the configuring including linking each virtual transaction instrument to one of the virtual user accounts;
a transactor, the transactor configurable to:
route deposits received for each of the virtual user accounts, as configured by the configurator, directly to the main account that is linked to the virtual user accounts; and
route payments from one or more of the main accounts;
an aggregator, the aggregator configurable to:
establish a communication channel with one or more of the transaction platforms;
receive, via the communication channel, a request for authorization of a payment request made using one of the virtual transaction instruments configured by the configurator; and
receive, via the communication channel, one or more authorization reports summarizing successful authorizations of payment requests;
a recorder, the recorder configurable to:
maintain a real-time balance for each virtual user account configured by the configurator;
an authorizer, the authorizer configurable to, for each request for authorization received by the aggregator:
identify a transaction amount in the payment request;
identify the virtual transaction instrument configured by the configurator used to make the payment request;
identify the virtual user account configured by the configurator to be directly linked to the identified virtual transaction instrument; and
when the real-time balance for the identified virtual user account maintained by the recorder is sufficient to cover the identified transaction amount in the payment request:
identify the payment request as being successfully authorized;
transmit, responsive to the received request for authorization, a successful authorization for the payment request; and
update the real-time balance maintained by the recorder with the identified transaction amount; and
a reconciler, the reconciler configurable to:
select, from the authorization reports received by the aggregator, successfully authorized payment requests that match the payment requests identified by the authorizer as being successfully authorized; and
instruct the transactor to make payment for the selected payment requests.

2. The system of claim 1, wherein:
the configurator is configured to identify a first main account and a second main account;
the configurator is configured to link the plurality of virtual user accounts to the first main account;
the transactor is configured to route deposits received for each of the virtual user accounts directly to the first main account;
the reconciler is configured to instruct the transactor to make payment for the selected payment requests from the second main account.

3. The system of claim 1, wherein one or more of the following apply:
the configurator is further configured to create the plurality of virtual user accounts; and/or
the configurator is further configured to create the plurality of virtual transaction instruments.

4. The system of claim 1, wherein, when the real-time balance for the identified virtual user account maintained by the recorder is insufficient to cover the identified transaction amount in the payment request, the authorizer is further configurable to:
identify the payment request as being unsuccessfully authorized; and
transmit, to the transaction platform that sent the request for authorization, an unsuccessful authorization for the payment request.

5. The system of claim 1, wherein one or more of the following apply:
at least one of the virtual transaction instruments are assigned to a user other than the main user;
at least one of the virtual user accounts are assigned to a user other than the main user;
one or more main accounts are financial accounts of the main user; and/or
each virtual transaction instrument is a virtual debit card and/or a virtual credit card.

6. The system of claim 1, wherein the configurator is further configurable to configure a plurality of sub-virtual user accounts, the configuring including linking the plurality of sub-virtual user accounts to one of the virtual user accounts, each sub-virtual user account assigned to one of the plurality of registered users

7. A method of processing communication requests submitted via one or more transaction platforms, the method comprising:
identifying, by a processor, one or more main accounts for a main user, the one or more main accounts for use by the main user to settle payments on behalf of a plurality of users for transactions submitted by the plurality of users via one or more transaction platforms;
creating, by the processor, a plurality of virtual user accounts, including a first virtual user account and a second virtual user account, each virtual user account configurable to be linked to the main account in such a way that deposits made to the virtual user account are directly routed to the main account;
associating, by the processor, each of the plurality of users with one of the virtual user accounts, including associating the first virtual user account with a first user and associating the second virtual user account with a second user;
creating, by the processor, a plurality of virtual transaction instruments, including a first user virtual transaction instrument and a second user virtual transaction instrument;
associating, by the processor, each virtual transaction instrument with one of the virtual user accounts, including associating the first user virtual transaction instrument with the first virtual user account and associating the second user virtual transaction instrument with the second virtual user account;
routing, by the processor, deposit transactions made to each virtual user account directly to the main account, including routing deposit transactions made to the first virtual user account to the main account and routing deposit transactions made to the second virtual user account to the main account;
receiving, by the processor via one or more transaction platforms, requests for authorization of payment requests made using the virtual transaction instruments, including payment requests made using the first user virtual transaction instrument and payment requests made using the second user virtual transaction instrument;
performing, by the processor, an authorization process to determine whether or not to authorize the payment requests made using the virtual transaction instruments, the authorization process including:
quantifying a real-time balance for the first virtual user account, the quantifying based on at least deposit transactions made to the first virtual user account and previous payment requests made using the first virtual transaction instrument that have been successfully authorized;
quantifying a real-time balance for the second virtual user account, the quantifying based on at least deposit transactions made to the second virtual user account and previous payment requests made using the second virtual transaction instrument that have been successfully authorized;
for each payment request made using the first virtual transaction instrument that requires authorization by the processor:
identifying a transaction amount in the payment request;
responsive to a determination that the quantified real-time balance of the first virtual user account is sufficient to cover the transaction amount in the payment request:
returning a successful authorization for the payment request; and
recording a deduction in the balance of the first virtual user account; and
responsive to a determination that the quantified real-time balance of the first virtual user account is not sufficient to cover the transaction amount in the payment request:
returning an unsuccessful authorization for the payment request; and
not recording a deduction in the balance of the first virtual user account; and
for each payment request made using the second user virtual transaction instrument that requires authorization by the processor:
identifying a transaction amount in the payment request;
responsive to a determination that the quantified real-time balance of the second virtual user account is sufficient to cover the transaction amount in the payment request:
returning a successful authorization for the payment request; and
recording a deduction in the balance of the second virtual user account; and
responsive to a determination that the quantified real-time balance of the second virtual user account is not sufficient to cover the transaction amount in the payment request:
returning an unsuccessful authorization for the payment request; and
not recording a deduction in the balance of the second virtual user account;
receiving, by the processor via one or more transaction platforms, one or more authorization reports summarizing the payment requests that have received successful authorizations from the authorization process;
performing, by the processor, a reconciliation process, the reconciliation process including selecting the successfully authorized payment requests summarized in the authorization reports that match the successfully authorized payment requests recorded, by the processor, during the authorization process; and
performing, by the processor, a settlement process, the settlement process including transferring, from one or more of the main accounts, payments for the payment requests selected in the reconciliation process.

8. The method of claim 7, wherein at least one of the virtual transaction instruments, including the first user virtual transaction instrument and the second user virtual transaction instrument, are assigned to a user other than the main user.

9. The method of claim 7, wherein at least one of the virtual user accounts, including the first virtual user account and the second virtual user account, are associated with a user other than the main user.

10. The method of claim 7, wherein the one or more main accounts are financial accounts of the main user, including a first main account and a second main account, the first main account for receiving deposits of funds from the plurality of virtual user accounts and transferring of deposited funds to the second main account, the second main account for receiving of funds from the first main account and performing the settlement process.

11. The method of claim 7, wherein each virtual transaction instrument is an internationally accepted form of payment.

12. The method of claim 7, wherein each virtual transaction instrument is a virtual debit card and/or a virtual credit card.

13. The method of claim 7, wherein the settlement process includes:
not transferring payments for those payment requests that were not selected during the reconciliation process.

14. The method of claim 7, further comprising creating, by the processor, a plurality of sub-virtual user accounts, including a first sub-virtual user account, each sub-virtual user account configurable to be linked to one of the virtual accounts in such a way that deposits made to the sub-virtual user account are directly routed to the virtual account linked to the sub-virtual account, wherein the first sub-virtual user account is linked to the first virtual user account.

15. A method of processing communication requests submitted via one or more transaction platforms, the method comprising:
identifying, by a processor, one or more main accounts for a main user, the one or more main accounts for use by the main user to settle payments on behalf of a plurality of users for transactions submitted by the plurality of users via one or more transaction platforms;
configuring, by the processor, a plurality of virtual user accounts, the configuring including linking one or more of the virtual user accounts to one of the main accounts in such a way that deposits made to each of the virtual user accounts are directly routed to the main account, each virtual user account assigned to one of the plurality of users;
configuring, by the processor, a plurality of virtual transaction instruments in such a way that each virtual transaction instrument is linked to one of the virtual user accounts;
responsive to the processor receiving, via one or more transaction platforms, a request for authorization of a payment request made using one of the virtual transaction instruments, performing, by the processor:
quantifying a real-time balance for the virtual user account that is directly linked to the virtual transaction instrument used to make the payment request;
identifying a transaction amount in the payment request;
returning a successful authorization for the payment request and recording a deduction in the balance of the virtual user account when the quantified real-time balance for the virtual user account is sufficient to cover the transaction amount in the payment request; and
returning an unsuccessful authorization for the payment request and not recording a deduction in the balance of the virtual user account when the quantified real-time balance for the virtual user account is insufficient to cover the transaction amount in the payment request;
receiving, by the processor via one or more transaction platforms, one or more authorization reports summarizing the payment requests that have received successful authorizations;
performing, by the processor, a reconciliation process, the reconciliation process including selecting the successfully authorized payment requests summarized in the authorization reports that match the successfully authorized payment requests recorded by the processor; and
performing, by the processor, a settlement process, the settlement process including transferring, from one or more of the main accounts, payments for the payment requests selected in the reconciliation process.

16. The method of claim 15, wherein at least one of the virtual transaction instruments are assigned to a user other than the main user.

17. The method of claim 15, wherein at least one of the virtual user accounts are assigned to a user other than the main user.

18. The method of claim 15, wherein the one or more main accounts are financial accounts of the main user, including a first main account and a second main account, the first main account for receiving deposits of funds from the plurality of virtual user accounts and transferring of deposited funds to the second main account, the second main account for receiving of funds from the first main account and performing the settlement process.

19. The method of claim 15, wherein each virtual transaction instrument is an internationally accepted form of payment.

20. The method of claim 15, wherein each virtual transaction instrument is a virtual debit card and/or a virtual credit card.

21. The method of claim 15, wherein the settlement process includes:
not transferring payments for those payment requests that were not selected during the reconciliation process.

22. The method of claim 15, further comprising configuring, by the processor, a plurality of sub-virtual user accounts linked to one of the virtual user accounts in such a way that deposits made to each of the sub-virtual user accounts are directly routed to the virtual user account linked to the sub-virtual user account.

23. A method of processing communication requests submitted via one or more transaction platforms, the method comprising:
identifying, by a processor, a main account for a main user, the main account for use by the main user to make payments on behalf of a plurality of users;
configuring, by the processor, a plurality of virtual user accounts, the configuring including linking the plurality of virtual user accounts to the main account, each virtual user account assigned to one of the plurality of users;
configuring, by the processor, a plurality of virtual transaction instruments, the configuring including linking each virtual transaction instrument to one of the virtual user accounts;
responsive to the processor receiving, from a transaction platform, a request for authorization of a payment request made using one of the virtual transaction instruments, performing, by the processor:
returning a successful authorization for the payment request and recording a deduction in a balance of a virtual user account linked to the virtual transaction instrument when the balance for the virtual user account is sufficient to cover a transaction amount in the payment request; and
a settlement process, wherein the settlement process includes a transferring, from the main account, of a payment for the payment request when the payment request is successfully authorized.
